(19) United States
(12) Patent Application Publication
(10) Pub. No.: US 2020/0372827 A1
(43) Pub. Date: Nov. 26, 2020

(54) Attribute Correlation Based Multiplication and Division System and Method

(71) Applicant: Alejandro Enrique Quinones Sattler, Ottawa (CA)

(72) Inventor: Alejandro Enrique Quinones Sattler, Ottawa (CA)

(21) Appl. No.: 16/767,672

(22) PCT Filed: Nov. 26, 2018
(86) PCT No.: PCT/CA2018/051499

§ 371 Date: May 28, 2020

Related U.S. Application Data
(60) Provisional application No. 62/591,547, filed on Nov. 28, 2017.

(51) Int. Cl. G09B 19/02

(52) U.S. Cl. CPC G09B 19/02

(57) ABSTRACT

A system and method for teaching multiplication and division using numerals ranging from “3” to “12” comprising a set of non-numerical representations, in on one or more fixed media formats. Each representation is distinguishable on the basis of one or more attributes to provide factor, factor operation and solution representations. An attribute of each factor representation can be manipulated by a user (learner) using a non-numerical operation to derive an attribute of the factor operation representation. Said derived attribute of the factor representation may be incorporated into the solution representation which encodes the solution of the factor operation. The shared attribute between the factor operation representation and solution representation allows the solution decoded from the solution representation to be readily correlated to the factor operation representation and accordingly recognized as the solution to the factor operation.

### FIELD OF THE INVENTION

The present invention relates to the field of systems methods for teaching and learning multiplication and division using numerals ranging from “3” to “12”.

### BACKGROUND OF THE INVENTION

The background to the invention provides information about the state of the art relating to methods and systems for teaching and learning the multiplication and division for numerals up to “12” as factors in simple, two-factor equations.

Many methods and devices have been developed to try to help children and other learners master the fundamentals of multiplication and division. Each of these has its limitations in terms of how effective they are for a wide demographic of learners.

A method is disclosed in U.S. Pat. No. 4,583,952 issued in the name of Evelyn De la Paz Rios wherein there is shown and described a “Method for Teaching Multiplication and Division with Numbers 6 through 9”. The De La Paz Rios method uses both hands, without any additional apparatus and requires from the students a mastery of multiplication for the numbers “1” through “5” and “10” to solve problems in multiplication and division involving the numbers “6” through “9”. This approach has limited capabilities to engage a wide demographic of learners with different learning styles and strengths.

Another method is disclosed in U.S. Pat. No. 6,155,836 issued in the name of Tapp Hancock, wherein there is shown and described a system for teaching mathematics using gloves and/or finger puppets with the digits representing non-sequential number series (e.g., two, four, six, etc.) Hancock's system to teach multiplication requires the mastering of the counting of a non-sequential numerical series (e.g., multiplication by six, for the numerical series “6”, “12”, “18”, 24″, etc.), and so on for each factor and the student takes on a largely receptive role again with limited opportunity for learners to be an active agent in the learning process.

U.S. Pat. No. 7,077,654 issued in the name of Jo Ann Burtness discloses a visual method of teaching arithmetic, in which graphical representations of familiar objects are used instead of numbers, for children who are visually oriented and have difficulty with numbers. The shapes of the objects resemble the numerals zero through nine. The objects may appear in any visual medium. Students are first shown examples of multiplication, division, addition, and subtraction, in which objects replace numbers. Each object is then shown by itself. The numeral that corresponds to the number value of each object is then overlaid on top of each object. Students are also shown groups of colored dots or balls, in which the colors of the dots match the colors of the objects and the number of dots corresponds to the numerical value represented by its corresponding object. This approach is focused entirely on reinforcing the visual recognition of individual numerals by consistently using the same non-numerical representations for a given numeral throughout the application of the method. While this approach provides for reinforced numeral recognition, it is not well adapted to provide factor operation, problem solving skill development.

U.S. Pat. No. 7,223,102 issued in the name of Larissa Powell discloses a system and method for teaching basic mathematical operations and facts; and more particularly an apparatus for the development of accurate and consistent conceptual models for learning certain math facts for the first time, wherein every digit of any number gets a consistent name. The name can be weaved into a story and rhyme throughout the learning process in both the math questions and in the math answers. For the learner, the consistent “name for a digit” approach that is disclosed provides some limited problem solving skill development, however, it is complex and cumbersome for learners who have difficulties learning or generating stories and phrases to associate non-numerical equation phrases to solution phrases and then decode the numerical counterparts from theses phrases.

It would be desirable to have relatively simple systems and methods that help learners master the multiplication and division for number values from “3” to “12”, wherein such methods are predicated on learners having already mastered the multiplication of the number values 5 (facts they learn from telling time) and 10 (very obvious and easy to learn). Such systems and methods can engage learners to be active agents in their learning by promoting the application multiple and preferred cognitive pathways, such as the use of physical movement, visual cues and other sensory capabilities.

Therefore, there currently exists a need in the industry for teaching and learning systems and methods that arouse curiosity and interest according to the needs and preferences of learners, with an underlying consistent approach for mastering with confidence the multiplication and division of operations using factors “3” to “12”, in a manner that is fun and easy-to-implement, and that may be deployed to promote active learner participation/engagement (e.g. physical movement).

### SUMMARY OF THE INVENTION

The present invention relates generally to systems and methods that engage students to learn multiplication and division using multiple cognitive and sensory processing pathways. The methods and systems disclosed herein are adaptable to the optimal processing pathways of learners and support the development of multiple cognitive skill sets such as recognition, correlation, derivation and decoding skill sets, to name a few. It is an object of the present disclosure to provide easy to apply methods and systems, which provide distinct non-numerical representations for: (i) numerical factors ranging from “3” to “12”; (ii) factor operations comprising said factors; and (iii) the solutions to the factor operations, wherein each non-numerical representation comprises one or more attributes that can be systematically associated with the numerical factors, factor operations and their solutions, respectively.

Unlike the prior art, rather than focusing on the consistent representation of individual numerals, the (non-numerical) representations are selected to facilitate the development of problem solving skill sets where leaners must derive, using a (specified) non-numerical operation, a distinct factor operation representation, wherein the factor operation representation is not a mere accumulation or compilation of the attributes of the factor representations. This is followed by a decoding step applied to the solution representation to determine the numerical solution to a given factor operation. A shared attribute can be used to correlate the solution representation to the factor operation representation and thereby allow learners to track solutions back to the subject factor operations. To further reinforce the development of problem solving and correlation skill sets, the shared attribute between the factor operation representation and solution representation may be the same attribute derived by performing the (specified) non-numerical operation using attributes of the factor representation.

In one aspect there is provided a system for teaching or learning multiplication and division comprising:

a. non-numerical representations for numerals and numerical operations fixed onto or generated using one or more learning aids, each of said non-numerical representations being distinguishable from the other non-numerical representations by one or more attributes to provide:
i. a factor representation for each numerical factor of a factor operation;
ii. a factor operation representation for the factor operation, derivable by performing a non-numerical operation using one or more of the one or more attributes of each of the factor representations to derive one or more attributes of the factor operation representation; and
iii. a solution representation encoding the numerical solution to the factor operation, comprising a shared attribute in common with the factor operation representation; and

b. instructions for:
i. recognizing each numerical factor based on the one or more attributes of each factor representation;
ii. applying the non-numerical operation to the factor representations to derive the factor operation representation of the factor operation;
iii. correlating the factor operation representation to the solution representation with reference to the shared attribute; and
iv. decoding the solution representation with reference to its one or more attributes to determine the numerical solution to the factor operation.

In another aspect there is provided a method of teaching or learning multiplication and division comprising the steps of:

a. presenting non-numerical representations for numerals and numerical operations fixed onto or generated using one or more learning aids, each of said non-numerical representations being distinguishable from the other non-numerical representations by one or more attributes to provide:
i. a factor representation for each numerical factor of a factor operation;
ii. a factor operation representation for the factor operation, derivable by performing a non-numerical operation using one or more of the one or more attributes of each of the factor representations to derive one or more attributes of the factor operation representation; and
iii. a solution representation encoding the numerical solution to the factor operation, comprising a shared attribute in common with the factor operation representation; and

b. executing instructions for:
i. recognizing each numerical factor based on the one or more attributes of each factor representation;
ii. applying the non-numerical operation to the factor representations to derive the factor operation representation of the factor operation;
iii. correlating the factor operation representation to the solution representation with reference to the shared attribute; and
iv. decoding the solution representation with reference to its one or more attributes to determine the numerical solution to the factor operation.

In embodiments of the system and method, the solution representation shares an attribute with the factor operation representation that was derived by performing the non-numerical operation.

In other embodiments of the system and method, one or more of the one or more attributes of the factor representations are physically manipulated by a user to perform the non-numerical operation to derive the factor operation representation.

In certain embodiments of the system and method, there are two numerical factors in the factor operation. In related embodiments, each numerical factor is the numeral “6”, “7”, “8” or “9”. In still other related embodiments of the system and method, one numerical factor is the numeral “3” or “4” and the other numerical factor is the numeral “6”, “7”, “8” or “9”.

In one embodiment of the system and method, each numeral in the numerical solution is encoded by a distinct attribute of the solution representation.

In another embodiment of the system and method, there are at least four factor representations each comprising a distinct primary colour or white colour attribute. In a related embodiment of the system and method, the non-numerical operation comprises the step of mixing the primary colour or white attributes of the factor representations to derive a colour product attribute of the factor operation representation (e.g. the colour product of mixing two primary colours).

In still another embodiment of the system and method, an attribute of the factor representation of one factor is an outline of an image and an attribute of the factor representation of the other factor is a colour. In a related embodiment of the system and method, the non-numerical operation requires the colouring of the outline of the image with the colour to derive the factor operation representation (coloured visual image).

In yet another embodiment of the system and method, the one or more learning aids includes a computer memory.

In a further embodiment of the system and method, the one or more learning aids are selected from the group consisting of flip cards, dominos, spin wheel, and a floor mat.

In still other embodiments, the system and method of the present disclosure is combined with a second system and method for teaching and learning multiplication and division, comprising a numbered track of numerals from three to twelve.

In another embodiment of the system and method, the non-numerical representations are displayed using a light projection system. The non-numerical representations may be projected onto a floor, wall, at or proximal to a video display screen.

In yet another embodiment of the system and method are configured as a kit of learning aids comprising the non-numerical representations and instructions in a print format, or fixed to a computer readable medium.

In still a further aspect there is provided a system of learning aids for teaching or learning multiplication and division, comprising sensible non-numerical representations of numerals and numerical operations, each representation being distinguishable one from the other by one or more attributes and corresponding to one of a factor in a factor operation to provide one or more factor representations, a factor operation to provide a factor operation representation, and a solution to the factor operation to provide a solution representation, wherein the factor operation representation is derivable by performing a non-numerical operation using one or more of the one or more attributes of the one or more factor representations, and the solution representation comprises a shared attribute with the factor operation representation.

In a further aspect there is provided a set of sensible, non-numerical representations of numerals and numerical operations, each representation being distinguishable one from the other by one or more attributes and corresponding to one of a factor in a factor operation to provide one or more factor representations, a factor operation to provide a factor operation representation, and a solution to the factor operation to provide a solution representation, wherein the factor operation representation is derivable by performing a non-numerical operation using one or more of the one or more attributes of the one or more factor representations, and the solution representation comprises a shared attribute with the factor operation representation

### BRIEF DESCRIPTION OF THE DRAWINGS

These and other features of the invention will become more apparent in the following detailed description in which reference is made to the appended drawings/figures as briefly described below.

FIG. 1: An exemplary set of distinguishable factor representations applied to a set of factors, the numerals “6”, “7”, “8” and “9”, with distinguishable colour attributes, selected from the colours yellow, red and blue, and white, respectively.

FIG. 2: Is an exemplary representation of a set of factor operation representations derived by applying a non-numerical operation using the colour attributes of two factor representations corresponding to the numerals of a factor operation.

FIG. 3: An exemplary (overlapping circle) format for deriving a factor operation representation obtained by mixing (blending) the colour attributes of factor representations.

FIG. 4: An exemplary (crashing car) format for deriving a factor operation representation obtained by mixing (blending) the colour attributes of factor representations.

FIG. 5: An exemplary factor operation format for deriving a factor operation representation obtained by mixing (blending) the colour attributes of factor representations.

FIG. 6: An exemplary set of solution representations encoding numerical solutions to factor operations, each sharing a colour attribute in common with a corresponding factor operation representation, as part of an image (with several attributes), whose name (attribute) rhymes with the name of the numerical solution.

FIG. 7: The exemplary set of solution representations of FIG. 6, with instructions for decoding from said solution representations the numerical solutions of the original (subject) multiplication factor operations corresponding to the related factor operation representations.

FIG. 8: A consolidated set of instructions and method steps for decoding a solution representation (entitled “GREEN Skate”) from FIGS. 6 and 7.

FIG. 9: Exemplary factor representations for the numerals “3” and “4”.

FIG. 10: Exemplary factor operation representations for a series of two-factor operations comprising the numeral “3” as a factor and the numerals “6”, “7”, “8” and “9” as the other factor in said factor operations.

FIG. 11: Exemplary factor operation representations for a series of two-factor operations comprising the numeral “4” as a factor and the numerals “6”, “7”, “8” and “9” as the other factor in said factor operations.

FIG. 12: Exemplary solution representations for the product (solution) of the factor operations shown in FIG. 10, wherein each solution representation is correlated to a corresponding factor operation representation by way of a shared colour attribute applied to an image (with multiple attributes) whose name (attribute) rhymes with the name of the numerical solution.

FIG. 13: Exemplary solution representations for the product (solution) of the factor operations shown in FIG. 11, wherein each solution representation is correlated to a corresponding factor operation representation by way of a shared colour attribute applied to an image (with multiple attributes) whose name (attribute) rhymes with the name of the numerical solution.

FIG. 14: The exemplary solution representations for the product (solution) of the factor operations shown in FIG. 10 shown on one side of a set of flip cards.

FIG. 15: The solutions/products of the factor operations shown in FIG. 10 on the opposite side of a set of flip cards in FIG. 14.

FIG. 16: An exemplary learning wheel for deriving factor operation representations for factor operations comprising the factor numeral “6” combined with various factor representations/attributes, as depicted in FIGS. 1 and 9.

FIG. 17: A learning tool fixed onto a medium, such as a mat, for use in delivering a visual and kinesthetic system and method for the multiplication and division of two-factor operations comprising the factor numerals three to twelve, as further described in Example 3.

FIG. 18: A learning tool comprising a combination of two teaching/learning systems fixed onto a medium, such as a mat for delivering visual and/or kinesthetic systems and methods for the multiplication and division of two-factor operations comprising the factor numerals three to twelve, as further described in Example 3.

FIG. 19: A learning wheel for use in embodiments of the system and method according to the present disclosure, to decode solution representations corresponding to factor operation representations and obtain the numerical solution of a multiplication (subject) factor operation based on the steps exemplified in FIGS. 7 and 8.

FIG. 20: A learning wheel for use in embodiments of the system and method according to the present disclosure, to match numerical solutions (products) to solution representations using the decoding steps exemplified in FIGS. 7 and 8. The same wheel can also be used to decode the solution (quotient) of a division operation.

FIG. 21: A wheel cover with windows for isolating the factor operation representation or product corresponding to a given solution representation, used to assist the learner to systematically decode the solution representations of FIGS. 19 and 20.

FIG. 22: An exemplary die design for use in embodiments of the system and method of the present disclosure for working with the factors “6”, “7”, “8” and “9” as well as factors “5” and “10”. A single die or set of dice according to the design shown can be used with the mat designs shown in FIGS. 17 and 18 in order for the learner to select various factors and factor operations.

FIG. 23: An exemplary set of domino designs for use in embodiments of the system and method of the present disclosure for working with the factors “6”, “7”, “8” and “9” and two-factor operations using said factors; wherein the learner is challenged to match products (numerical solutions) with solution representations.

FIG. 24: Another exemplary set of domino designs for use embodiments of the system and method of the present disclosure for working with the factors “6”, “7”, “8” and “9” and two factor operations using said factors, wherein the learner is challenged to match products (numerical solutions) with solution representations. The domino sets of FIGS. 23 and 24 work together to provide a complete set of dominos for all of the possible two-factor operations using the factors “6”, “7”, “8” and “9”.

FIG. 25: An exemplary visual and kinesthetic method step for learners to test their knowledge of factor operation solutions and associate the products with a colour attribute used in the factor operation representations of embodiments of the system and method according to the present disclosure. By stepping on and lighting up the answer to a given factor operation, e.g. “6×6”, a learner can identify or select which operations to work on using the system and method provided.

FIG. 26 (a-e): An exemplary visual and kinesthetic system and method according to the present disclosure implemented using a light projection (sub)system to visually guide and display to learners the results of their movement in accordance with instructions for working with the various factor numerals, factor operations and corresponding non-numerical representations to obtain the solution of a given factor operation.

FIG. 27 (a-j): Illustration of an alternative system and method for teaching and learning the multiplication of two-factor operations (e.g. “6×7”) that can be combined with the system and method of the present disclosure as shown in FIG. 18.

FIG. 28 (a-p): Illustration of an alternative system and method for teaching and learning the multiplication of two-factor operations (e.g. “7×8”) that can be combined with the system and method of the present disclosure as shown in FIG. 18.

FIG. 29 (a-h): Illustration of an alternative system and method for teaching and learning the multiplication of two-factor operations (e.g. “4×6”) that can be combined with the system and method of the present disclosure as shown in FIG. 18.

FIG. 30 (a-n): Illustration of an alternative system and method for teaching and learning the multiplication of two-factor operations (e.g. “3×7”) that can be combined with the system and method of the present disclosure as shown in FIG. 18.

### DETAILED DESCRIPTION OF THE INVENTION

The present invention relates to the field of teaching and learning systems for multiplication and division operations, for example, involving two-numeral operations with values ranging from “3” to “12” for learners who have already mastered multiplication operations using the numerals “1”, “2”, “5” and “10”. Further mastery of multiplication and division operations according to the present disclosure also allows for the application of the system and method provided herein to numerals greater than “12” and for operations which involve more than two numerals.

As demonstrated herein, a versatile system and method is disclosed which can apply numerous kinds of devices, articles and system configurations for learners to master multiplication and division operations.

Various features of the invention will become apparent from the following detailed description taken together with the illustrations in the Figures. The design factors, construction and use of the system and method disclosed herein are described with reference to various examples representing embodiments, which are not intended to limit the scope of the invention as described and claimed herein. The skilled technician in the field to which the invention pertains will appreciate that there may be other variations, examples and embodiments of the invention not disclosed herein that may be practiced according to the teachings of the present disclosure without departing from the scope and spirit of the invention.

### Definitions

Unless defined otherwise, all technical and scientific terms used herein have the same meaning as commonly understood by one of ordinary skill in the art to which this invention pertains.

The use of the word “a” or “an” when used herein in conjunction with the term “comprising” may mean “one,” but it is also consistent with the meaning of “one or more,” “at least one” and “one or more than one.”

As used herein, the terms “comprising,” “having,” “including” and “containing,” and grammatical variations thereof, are inclusive or open-ended and do not exclude additional, unrecited elements and/or method steps. The term “consisting essentially of” when used herein in connection with a composition, device, article, system, use or method, denotes that additional elements and/or method steps may be present, but that these additions do not materially affect the manner in which the recited system and method (including any compositions, devices and articles of various embodiments, or different uses) function. The term “consisting of” when used herein in connection with a composition, device, article, system, use or method, excludes the presence of additional elements and/or method steps. A composition, device, article, system, use or method described herein as comprising certain elements and/or steps may also, in certain embodiments consist essentially of those elements and/or steps, and in other embodiments consist of those elements and/or steps, whether or not these embodiments are specifically referred to.

As used herein, the term “about” refers to an approximately +/−10% variation from a given value. It is to be understood that such a variation is always included in any given value provided herein, whether or not it is specifically referred to.

The recitation of ranges herein is intended to convey both the ranges and individual values falling within the ranges, to the same place value as the numerals used to denote the range, unless otherwise indicated herein.

The use of any examples or exemplary language, e.g. “such as”, “exemplary embodiment”, “illustrative embodiment” and “for example” is intended to illustrate or denote aspects, embodiments, variations, elements or features relating to the invention and not intended to limit the scope of the invention.

As used herein, the terms “connect”, “connection” and “connected” refer to any direct or indirect, tangible or intangible association between elements or features of the system and method of the present disclosure, as well as to processes which correlate certain information to other information. Accordingly, these terms may be understood to denote elements or features that are partly or completely contained within one another, attached, coupled, disposed on, joined together, matched, coordinated, linked, etc., even if there are other elements or features intervening between the elements or features described as being connected, or multiple steps for correlating one bit of information to another bit of information.

As used herein, the term “attribute” refers to a part, or aspect of a representation that can be identified (sensed) using one or more sensory skills (e.g. sight, hearing, touch, smell, taste), such as, but not limited to a feature, characteristic or quality of an image, physical entity, sensation(s), or sound(s). A sensible attribute may also be expressed as a combination of other attributes. Certain attributes according to the present disclosure may be used, or applied to identify or represent numerals (e.g. factors and products), to perform non-numerical operations, correlate and derive representations, or to decode (numerical) information.

As used herein, the term “colour” is used to describe individually and collectively primary and complementary colours, tints, hues and shades of colours, white and black, and generally, all visual manifestations or representations of products of colour mixing, or blending.

As used herein, the terms “expression(s)”, “express” and “expressed” refer to a particular manifestation (tangible and intangible) of an idea, concept, entity, relationship, method, and process for the purposes of facilitating human communication, knowledge, comprehension, making, creation and innovation. The distinguishing function, features, aspects, or qualities of different expression(s) may give rise to distinguishable or distinct representations and attributes according to the present disclosure.

As used herein, the term “factor” refers to a numeral which forms part of a multiplication operation (expression) to be solved. Since the system and method of the present disclosure allows for the mastery of division operations based on developing a mastery of multiplication operations, a factor may also be correlated to, or used to describe a divisor or quotient of a division operation.

As used herein, the term “operation” refers to carrying out one or more steps which require problem solving skill(s) to be applied to a problem to arrive at a result. An operation may be represented as the problem to be solved or as the series of steps that need to be taken to arrive at a result. Various mathematical or numerical operations may include, but are not limited to multiplication, division, addition and subtraction. Non-numerical operations may include, but are not limited to, computer or software code operations, and operations based on scientific and engineering principles (e.g. colour theory, chemistry, physics, etc.). Without limitation, an operation may comprise the application of a series of correlation and matching steps and/or the application of provided or acquired knowledge of STEM principles or concepts. An operation may also include the application of fine arts and language skills, alone, or as steps in addition to the application of STEM-based problem solving skills (STEAM) to execute an operation (e.g. using the senses, motor skills and vocalizations).

As used herein, the term “representation” refers to an alternative expression of a pre-existing expression that can be or is correlated (corresponds) to said pre-existing expression for the purposes of working the system and method according to the present disclosure.

It is contemplated that any embodiment of the compositions, devices, articles, methods and uses disclosed herein can be implemented by one skilled in the art, as is, or by making such variations or equivalents without departing from the scope and spirit of the invention.

### System of Non-Numerical Representations for Factors, Factor Operations and Solutions

The system and method of the present disclosure break down the process of discovering and learning the solution to a factor operation by creating a set of surrogate (non-numerical) expressions that account for each element of a multiplication or division equation (i.e. the factors, factor operation and solution). Non-numerical representations selected to represent numerical parts of a multiplication or division equation, are selected to be distinguishable (distinct) from one another, and able to be manipulated or applied so as support the development of multiple problem solving skills.

While the prior art has utilized non-numerical surrogate expressions for numerals and solutions previously, such expressions have tended to use such expressions for representing the factors and solutions only, and to prefer to apply the same representations for the same numerals, wherever they appear in the operation or solution.

Moreover, prior approaches have not been designed to facilitate the application of a non-numerical operation to derive a factor operation representation, as a distinct representation from each of the factor representations and solution representation. The non-numerical operation of the present system and method is executed using one or more attributes of the factor representations to derive (or create) the distinct factor operation representation. Accordingly, the non-numerical operation can be understood as a transformation or manipulation of the factor representations rather than simply working with a compilation of the factor representations.

By creating a factor operation representation that is removed from the confines of the format of the numerical operation, a demarcation, pivot or grounding point is provided for in the system and method to open up the design of the solution representations encoding the solution to a plethora of options adapted to the learning styles and strengths of learners. This system and method configuration provides another level of problem solving following the non-numerical operation and allows learners to track the decoded solution (via the factor operation representation) back to the starting subject (numerical) operation. The tracking capability is provided by means of one or more (sensible) shared attributes between a factor operation representation and a solution representation. The shared attribute(s) may or may not be one or more of the attributes of the factor operation representation that were derived by applying the non-numerical operation to the factor representations.

In one embodiment, two factor representations (of factors to be combined into a single factor operation) are used to derive a single factor operation representation (using a non-numerical operation) and the factor operation representation is applied with a solution representation (leveraging a shared attribute) to decode the numerical solution.

In another embodiment, three or more factor representations are used to derive new, intermediate factor representations, factor operation representations and solution representations, as part of a more complex multiplication or division problem. In a related embodiment the complex multiplication or division problem is based on three factors combined into a single factor operation. In a further embodiment, the complex multiplication or division problem is based on four factors combined into a single factor operation. In still another embodiment, the complex multiplication or division problem is based on two pairs of factors each combined into first and second two factor operations, the numerical solutions to which are then used to form a third two factor operation.

For example, starting with three factor representations (representing three factors to be combined into a single factor operation), two of the factors representations can be used to derive a first factor operation representation using a non-numerical operation. The first factor operation representation can then function as a fourth factor representation to be applied with the third factor representation to derive a second factor operation representation. The second factor operation representation will, in turn, be applied with a first solution representation (leveraging a shared attribute) to arrive at the numerical solution for the original three factor operation.

Alternatively, working with three factor representations (representing three factors combined into a single factor operation), two of the factors representations can, again, be used to derive a first factor operation representation using a non-numerical operation. This time, however, the first factor operation representation is applied with a distinct (first) solution representation (again leveraging a shared attribute) to arrive at a numerical solution. This numerical solution can be assigned a distinct (fourth) factor representation and used with the third factor representation to derive a distinct (second) factor operation representation. The second factor operation representation in this instance would then be applied with a further (second) solution representation to decode the final numerical solution to the original three factor operation.

In one embodiment of the system and method, the non-numerical representations are visual representations. In another embodiment, the non-numerical representations are auditory representations. In still another embodiment the non-numerical representations are tactile/kinesthetic representations. In related embodiments, the non-numerical representations are combinations of visual, auditory and tactile/kinesthetic representations.

To make the delivery of the system and method more engaging for learners, the level of interactivity can be supported using various technologies, environments and instruction that support and promote vocalization and physical activity. This requires the fixing of, or ability to generate the non-numerical representations using one or more of a variety of media and/or learning aids.

In certain embodiments of the system and method, visual representations are fixed to or generated using one or more learning aids such as paper, computer memory (and generated, e.g. projected as or at a light display) and 3D articles or devices. In one embodiment of the system and method, the visual representations are fixed in a workbook or worksheets. In another embodiment, each visual representation is fixed to a device or article, such as, but not limited to, blocks, balls, flip cards, learning (spinner) wheels, discs, dice, dominos, and the like. A group of visual representations fixed to such devices or articles may or may not be configurable on boards, frames or other support structures designed to accommodate the movement, sorting, storing and/or manipulation of the fixed visual representations (e.g. an abacus-like structure).

In yet another embodiment, visual representations are generated using electronic devices, systems and methods, such as projection at or proximal to a video display. In a still another embodiment, visual representations are projected to a floor or wall, or as a hologram in a space. In a further embodiment, visual representations are presented or generated using assistive technologies for learners with disabilities (e.g. computer vocalizations of visual representations for vision impaired learners). In one embodiment, visual representations are presented within a video game. In a related embodiment, visual representations are presented within a virtual reality system.

In still another related embodiment, visual representations may be displayed on a mobile hand-held device used to generate short video, which animate the visual representations displayed in a workbook or other tangible medium for displaying static images. Such short video (e.g. in mp4 format) can be used to help highlight for the user the salient features of the representation that can be used to perform derivation steps to obtain factor operation representations and perform decoding steps to obtain numerical solutions from the solution representations.

In some embodiments of the system and method, auditory representations are generated and delivered as musical notes or sounds. In one embodiment, the auditory representations are the notes of one or more musical scales. In another embodiment, the auditory representations are selected from sounds experienced in different environments, such as natural habitats and industrial settings. In still a further embodiment, the auditory representations are generated using articles made of different materials such as metals, glass, wood, plastic and the like. In a further embodiment, the auditory representations are generated using an electronic device, computerized sound synthesizer system and the like.

In still other embodiments of the system and method, kinesthetic representations are provided as objects with touch distinguishable surfaces and features, or as objects used to perform various activities or actions. Exemplary textured surfaces include, but not are limited to, different types of fabrics, metal, glass, plastics and wood materials. Exemplary categories of touch-distinguishable objects/features include, but not are limited to, fruit and vegetables, garden specimens, differently sized blocks and balls, and discs with perforations or elevated protrusions.

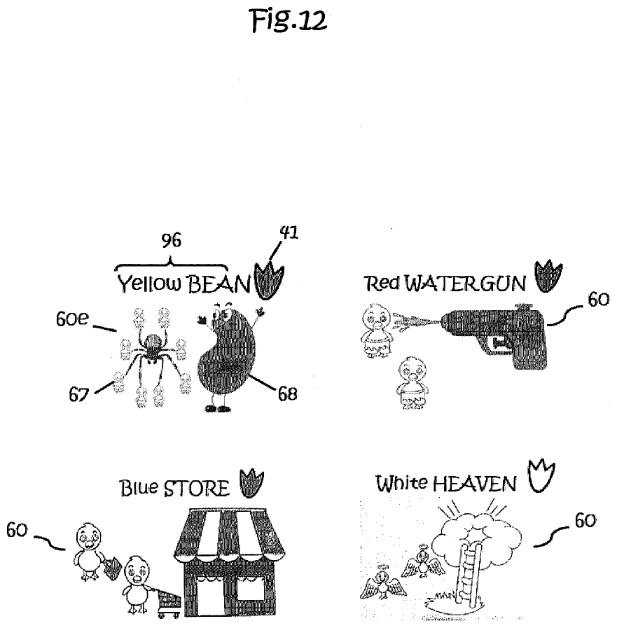

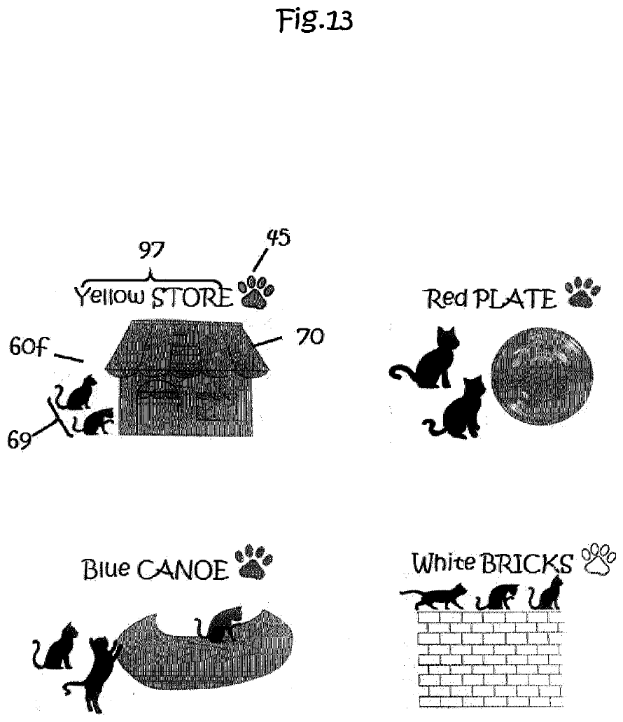

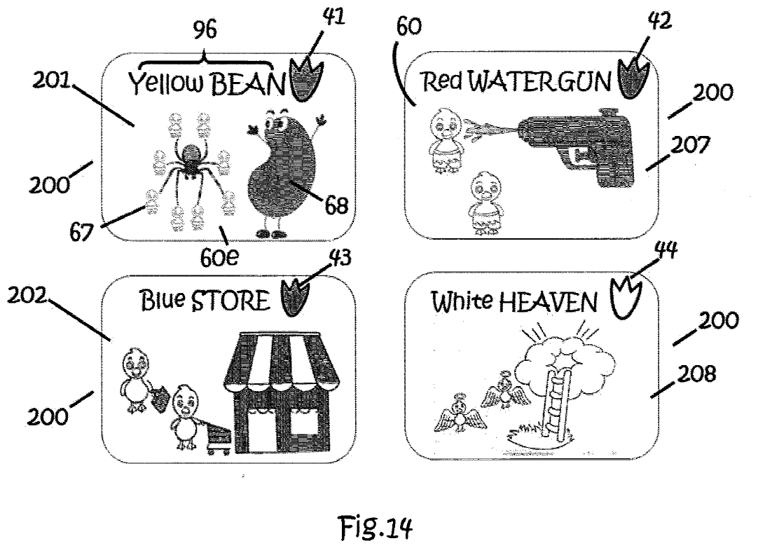

In another embodiment, textual aids can be provided to enhance engagement and provide clues or instructions for using system and performing the method of the present disclosure. For example, with reference to FIGS. 12 and 13, the solution representations can be decoded with the aid of story-telling techniques, written or told, as exemplified in Example 2.

Categories or groupings of factor representations (based on one or more distinguishable attributes) are selected so as to provide a basis and scheme for performing the non-numerical operation to derive the factor operation representations. In one embodiment, colour can be applied as the distinguishing attribute of factor representations and manipulated using colour theory to derive factor operation representations. In another embodiment, foods or food ingredients (factor representations) selected from various food groups can be applied to derive balanced meals (factor operation representations) according to nutritional science. In still another embodiment, seeds and the elements needed for germination (factor representations) can be used to derive different plants (factor operation representations) according to plant science. In a further embodiment, two musical notes from a chord (factor representations), visually or audibly conveyed, can be used (as the attributes used to derive the third note that completes the chord (factor operation representations).

The solution representations need not fit into or form part of the scheme of factor representations so long as one or more attributes of the derived factor operation representations is/are shared with the corresponding solution representations. The function of the solution representation is to be a self-contained encoding of the product (solution) of the subject numerical operation. The versatility of the solution representations that can be designed arises by not requiring the factor representations to represent the same numerals in the solution representation. Nor does the shared attribute between the solution representation and corresponding factor operation representation have to be part of the “coding” for the numerical solution. The primary shared attribute(s) function is as a tracking mechanism for the learner to match the solution decoded from the solution representation back to the starting (subject) numerical operation.

In one embodiment, different attributes of the solution representation encode different numerals in the solution to a (numerical) factor operation. In another embodiment, different attributes of the solution representation encode two or more surrogate numerical expressions of the solution to a factor operation and cues to add and/or subtract the expressions to/from one another to obtain the solution to the factor operation.

### Methods for Using System of Non-Numerical Representations for Factors, Factor Operations and Solutions

The application of the system of the present disclosure comprising non-numerical factor representations, factor operation representations and solution representations is as a teaching and learning method for multiplication and division operations. Learners are able to self-teach using the system according to the present disclosure to the extent and degree they choose. Embodiments of the system may be provided as kits providing the non-numerical representations for the factors, factor operations and solutions in the form of various learning aid components, such as, but not limited to workbooks, mats, blocks, electronic hand-held devices, and instructional components for working with the learning aid components (i.e. non-numerical representations).

The versatility of the system and method according to the present disclosure is its modular design and staged process to work through a given multiplication or division problem, as well as the cross-curricular opportunities it offers for integrating STEM, social studies, and fine arts/language strands from school curriculums. This supports the development of knowledge and problem solving skills reflecting the application of concepts and ideas covered in curriculums. The system and method of the present disclosure also support the needs of learners with varying aptitudes, and provide options for learning multiplication and division operations in a fun and engaging manner. The opportunities for cross-curricular integration in the deployment of the system and method in schools allow for its application in classroom and gymnasium settings, and for group instruction, peer learning and self-instruction formats.

In one embodiment, the method according to the present disclosure comprises the step of identifying or correlating a set of distinct factor representations to a set of numerical factors (which form part of possible subject factor operations), deriving the factor operation representation by performing a non-numerical operation using the applicable factor representations, correlating the factor operation representation to a solution representation on the basis of one or more shared attributes and decoding the solution representation to discover and obtain the solution to a given subject factor operation.

Additional steps can be included in the method to pre-test a learner's knowledge, ability to solve various factor operations and/or validate the solution obtained using the method according to the disclosure. This allows the learner to determine which factor operations to solve using the system and method of the present disclosure. Other steps can be incorporated to reinforce the learners ability to perform any one or more of the steps for solving the factor operation, such as exercises to more readily identify the factor representations for the factors, exercises to practice the application of the non-numerical operation to derive the factor operation representations and using alternative systems and methods for double checking the solution decoded from the solution representations.

To gain a better understanding of the invention described herein, the following examples are set forth. It will be understood that these examples are intended to describe illustrative embodiments of the invention and are not intended to limit the scope of the invention in any way.

### EXAMPLES

The following examples are illustrative of the system and method according to the present disclosure and described with reference to the figures/drawings indicated. Each implementation of the system and method described below relates to providing learners with a means to: (1) solve two-numeral multiplication and division, with numerals in the range of “3” to “12”; (2) develop logic and math based skills in a way which can be experienced or leveraged using cross-curricular subject matter, multiple sensory and cognitive pathways, and skills; and (3) obtain the support needed to learn subject (numerical) operations to a degree and extent that the learner controls (which has a positive impact on learner self-esteem).

### Example 1: Exemplary System and Method for Multiplication of Numerals 6, 7, 8, and 9 (Colour Mix Approach)

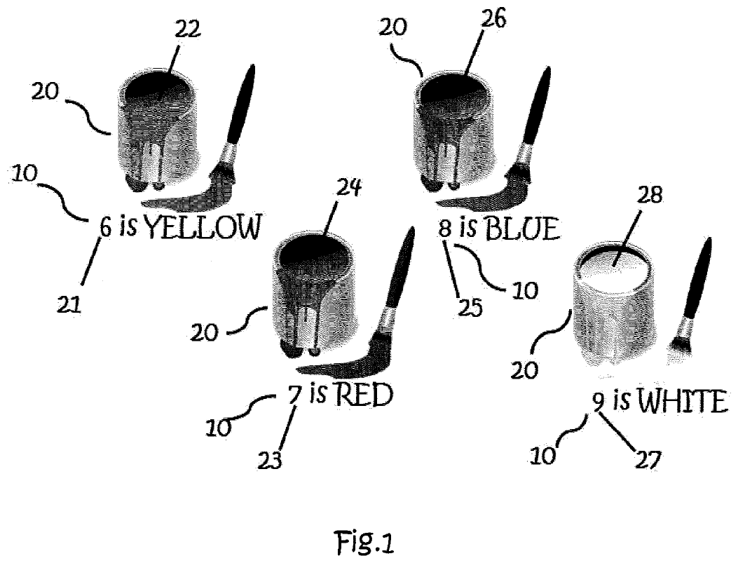

In one embodiment of the system and method according to the present disclosure, FIG. 1 provides the factor representations 20 for the factors 10 that will be applied by the learner to learn how to multiply the numerals six to nine in simple two factor operations. The factors 10 for the numerals six 21, seven 23, eight 25 and nine 27 are assigned a primary colour or white as an attribute of their respective factor representations 20 where: the colour yellow 22 is an attribute of the factor representation 20 for the numeral/factor 10, six 21; the colour red 24 is an attribute of the factor representation 20 for the factor 10, seven 23; the colour blue 26 is an attribute of the factor representation 20 for the factor 10, eight 25; and the colour white 28 is an attribute of the factor 10, nine 27.

The factor representations 20 may have additional attributes such as the form of paint cans and their respective brushes to make the imagery more memorable as well as to give an indicator of the type of non-numerical factor operation that will be applied when using the factor representations 20 to derive the factor operation representation.

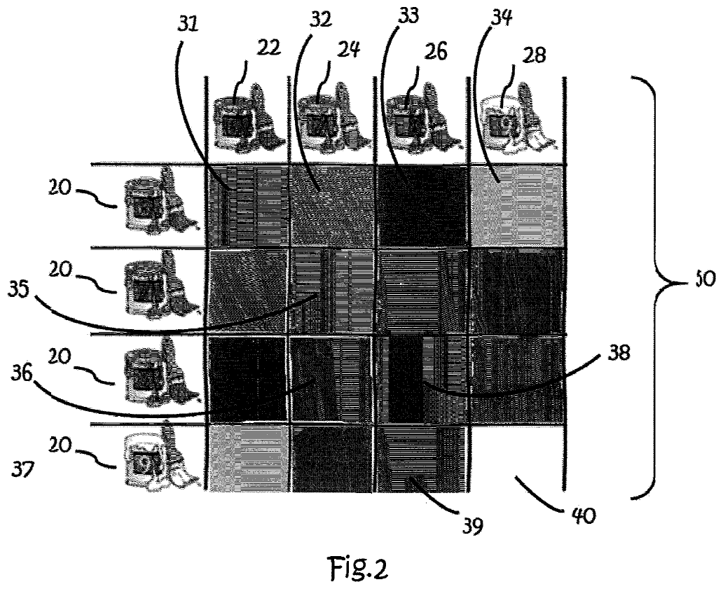

FIG. 2 illustrates the non-numerical operation (and instructions in a tabular format) performed by the learner with the factor representations 20. The non-numerical operation entails mixing or blending two of the primary colour or white attributes 22, 24, 26 and 28, respectively, to derive the factor operation representations 50. By performing the colour mixing operation, distinguishing colour attributes 31-40 of the factor operation representations 50 are produced (derived).

More specifically, each numerical factor operation (and its product) aligns with a derived factor operation representation attribute (FORA) based on mixing two-factor representation attributes (FRAs) indicated along each axis of the grid/table in FIG. 2 as follows:
1. 6×6 is represented by mixing the FRAs, yellow 22 with yellow 22 to derive the FORA, yellow 31;
2. 6×7 is represented by mixing the FRAs, yellow 22 with red 24 to derive the FORA, orange 32;
3. 6×8 is represented by mixing the FRAs, yellow 22 with blue 26 to derive the FORA, green 33;
4. 6×9 is represented by mixing the FRAs, yellow 22 with white 28 to derive the FORA, light yellow 34;
5. 7×7 is represented by mixing the FRAs red 24 and red 24 to derive the FORA, red 35;
6. 7×8 is represented by mixing the FRAs, red 24 and blue 26 to derive the FORA, purple 36;
7. 7×9 is represented by mixing the FRAs, red 24 and white 28 to derive the FORA, pink (light red) 37;
8. 8×8 is represented by mixing the FRAs, blue 26 and blue 26 to derive the FORA, blue 38; and
9. 8×9 is represented by mixing the FRAs, blue 26 and white 28 to derive the FORA, light blue 39; and
10. 9×9 is represented by mixing the FRAs, white 28 and white 28 to derive the FORA, white 40.

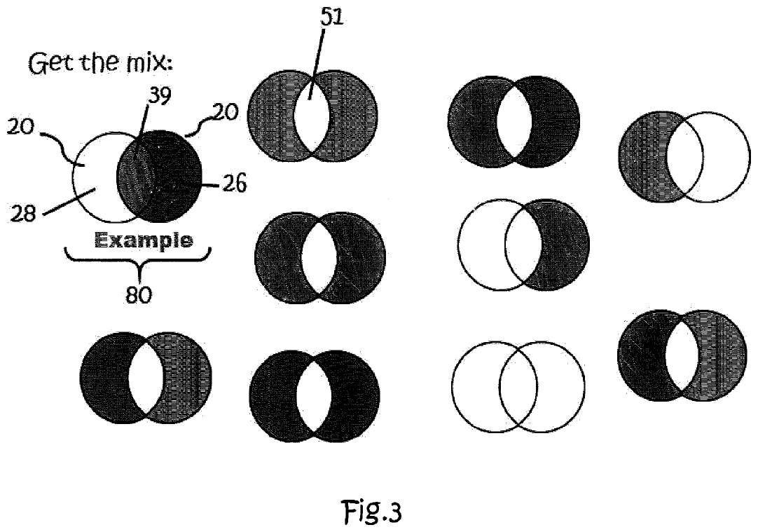

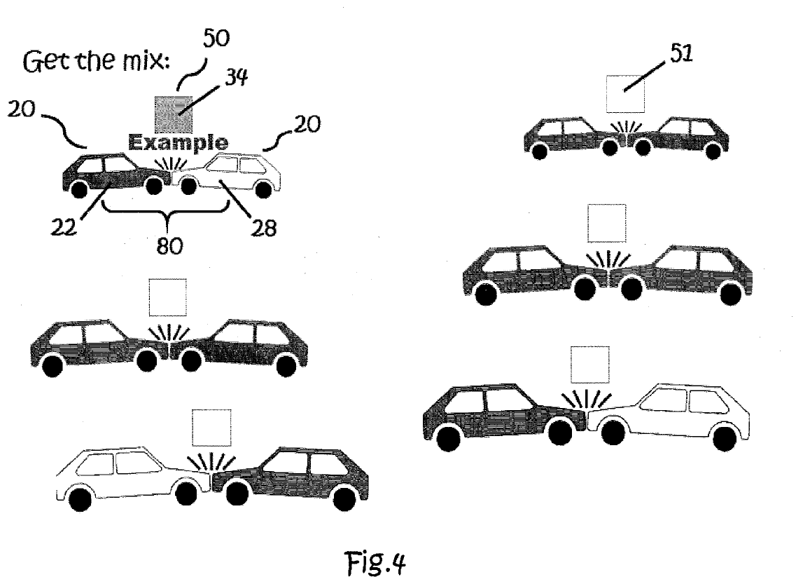

As further illustrated in FIGS. 3 and 4, the learner can practice the colour mixing (non-numerical) operation 80 in various ways to derive a factor operation representation 50 by colouring in the space 51 provided where the factor representations 20 overlap (circles in FIG. 3), or else proximal to where the factor representations meet (cars colliding in FIG. 4).

While certain attributes of the factor representations 20 can change as shown in FIGS. 3 and 4 (i.e. circle shapes in FIG. 3 and car images in FIG. 4) and even be shared between factor representations (e.g. all of the factor representations are car images in FIG. 4), there is at least one attribute which distinguishes each factor representation from other factor representations (such as different colours) and which is used to perform the non-numerical operation (colour mixing) to derive a corresponding factor operation representation 50.

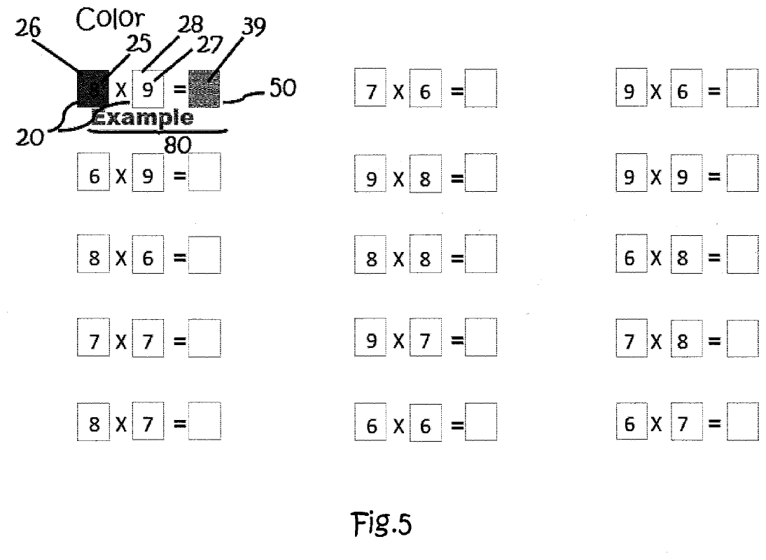

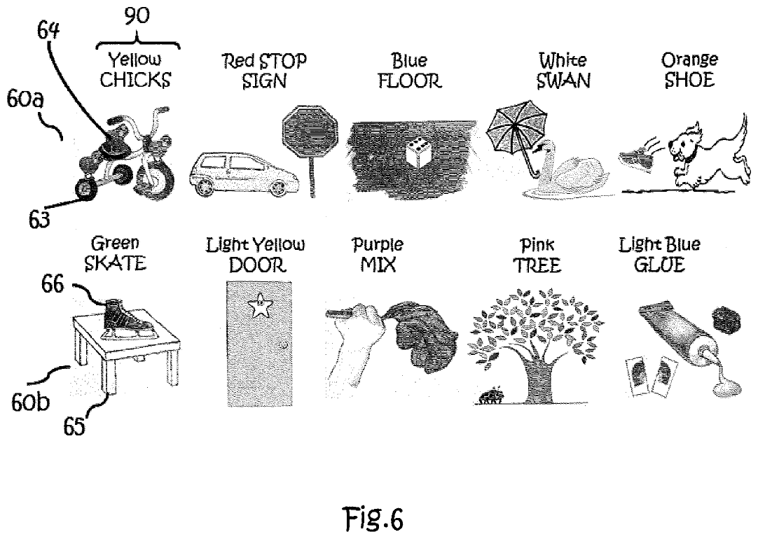

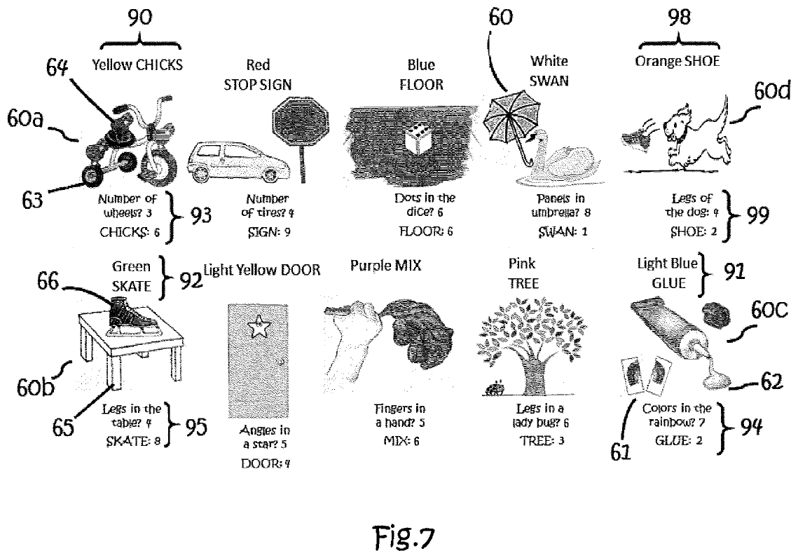

This is demonstrated further in FIG. 5, where the factor representations 20 are coloured squares overlaid over their corresponding numerical factors, eight 25 and nine 27, and their respective colour attributes 26 and 28 are mixed by the learner to derive the factor operation representation 50 comprising the colour attribute 39. Set out in a familiar factor operation format, a factor operation representation 80 can also be readily correlated with the product of the factor operation and accordingly with a solution representation (shown generally as 60 and exemplified particularly as 60a, 60b, 60c and 60d) in FIGS. 6 and 7. In these figures, the particular factor operation representation 50, with colour attribute 39 (light blue), from FIG. 5, correlates with the solution representation 60c comprising the image attribute 62 shown as (light blue) glue. A word title 91 is also provided to help the learner focus on the attribute 62 of the solution representation. This title 91 can be understood as another attribute of the solution representation, which functions as an aspect of the instructions for decoding the solution representation in the form of a clue.

The use of multiple attributes in non-numerical representations, as demonstrated in this instance, allows for the application of the system and method according to the present disclosure when not all of the attributes can be sensed or processed with the same degree of ease. In the case of the “Light Blue GLUE” title/attribute 91 the learner is provided a means for decoding that particular solution representation 60c, even if the colour of the glue image is not apparent, e.g. because the learner has a vision disability (colour blindness), or because of the image being reproduced in black and white. Similarly, the system and method can be configured so that the title/attribute 91 is provided as an auditory cue attribute, or in brail (textured attribute) for learners who are blind or visually impaired.

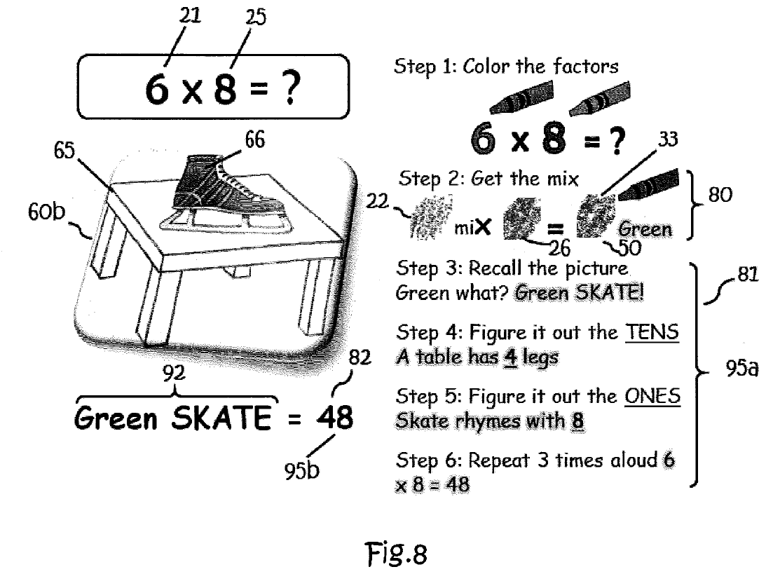

To decode a solution representation 60 and obtain the product (numerical solution 81) of a factor operation, the learner is provided with guidelines or instructions (a logic operation) with reference to various attributes, as shown in FIG. 7 for a given solution representation. The combined logic and product solution feature of the system and method is labelled in a generalized sense as feature 81 of FIG. 8 with reference to the solution representation 60b from FIG. 7, where the specific decoding logic and numerical solution (product) for this solution representation is labelled as feature 95 in FIG. 7 and still more particularly as features 95a and 95b, respectively, in FIG. 8.

Applying the generalized logic to the solution representation entitled “Light Blue GLUE”, two or more of the attributes of the solution representation are used to decode the product/solution “72” of the factor operation “8×9”. Coupled with the light blue glue 62 and title 91 is an image of a rainbow 61. With reference to feature 94 of FIG. 7, the rainbow attribute 61 with its seven colours provides the numeral “7”. To obtain the numeral “2” a rhyme association is made by sounding out the terms “GLUE” and “two” having regard to the image attribute(s) light blue glue 62 and/or the title 91 “Light Blue GLUE”.

The capitalization of all of the letters of the term “GLUE” to be sounded out, in contrast to the descriptor “Light Blue” provides a visual cue regarding the instructions and also exemplifies how the colour attribute used to correlate the factor operation representation to the solution representation (to the product of the factor operation), need not necessarily be used to decode the solution/product itself.

The method described above for discovering and learning the solution of a given factor operation is consistently applied to decode the ‘tens’ and ‘ones’ place value numerals of the solutions (products) of the subject factor operations the learner is presented with (having regard to the respective factor operation representation and solution representation pairings). As shown in FIGS. 6 and 7, the solution “36” and logic for discovering the solution (labelled as feature 93 in FIG. 7) to the factor operation “6×6” is discovered by correlating the factor operation representation colour attribute, yellow 31 (from FIG. 2) to the same colour attribute appearing in the solution representation 60a with the title attribute “Yellow CHICKS” 90. The image of the tricycle has three wheels from which to decode the numeral “3” (tens' place value) and the numeral “6” (ones' place value) is decoded based on sounding out and hearing the rhyme between the terms “CHICKS” and “six” (again with reference to the title 90 and/or chick image 64).

With reference to FIG. 8, the exemplary system and method for a colour mixing approach to discovering and learning the product 95 for the factor operation “6×8” (i.e. “48”) is set out. On a general level, the process steps of decoding a solution representation is indicated by the feature label 81 and the resulting numerical product by the feature 82. With reference to the specific example shown, the learner is first guided to correlate the factors 21 (numeral “6”) and 25 (numeral “8”) to distinct non-numerical, factor representations, with colour attributes, yellow 22 and blue 26, respectively (Step 1). The colour attributes of the (non-numerical) factor representations are mixed according to a non-numerical operation 80 (i.e. using colour science) to derive a factor operation representation 50 with the colour attribute, green 33 (Step 2). Using the logic operation 95a for the solution representation 60b the learner is guided to discover the numerical solution 95b. The green attribute 33 of the factor operation representation is a shared attribute with the solution representation 60b comprising several distinguishing attributes, including but not necessarily limited to, a title (“Green SKATE”) 92, image of a green skate 66 and a table 65. The shared green attribute 33 facilitates the correlation of the factor operation representation 50 to the solution representation 60b (Step 3). The four legs of the table image 65 provide the numeral “4” of the solution (Step 4) and sounding out the rhyme association between the terms “SKATE” and “eight” provide the numeral “8” of the solution (Step 5). The final association/connection between the original factor operation “6×8” is then made with the discovered solution/product “48” (Step 6).

### Example 2: Exemplary System and Method for Multiplication of Numerals 4 and 3 with Numerals 6, 7, 8, and 9

In another exemplary embodiment according to the present disclosure a system and method are provided for teaching and learning to multiply each of the factors “3” and “4” with each of the factors “6”, “7”, “8” and “9”.

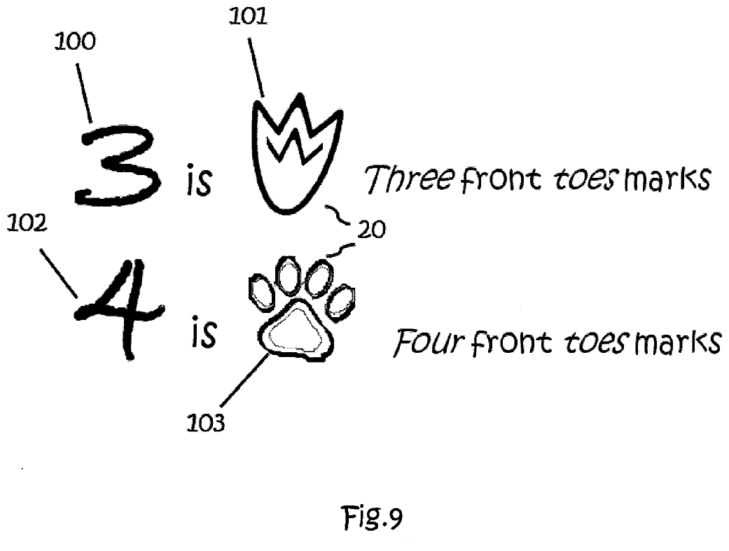

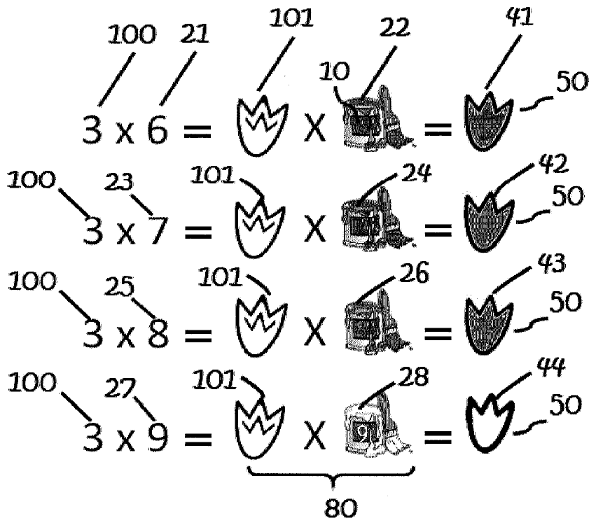

With reference to FIG. 9, the factor representations 20 for the factors “3” 100 and “4” 102, are paw image outlines 101 and 103 with three and four toes, respectively. These factor representations 20 are combined with the primary colour and white attributes of the factor representations described in Example 1 for each of the factors/numerals “6”, “7”, “8” and “9”, respectively.

With reference to FIG. 10, each numerical factor operation (and its product) aligns with a derived factor operation representation attribute (FORA) based on colouring the factor representation attributes (FRAs) for the factor/numeral “3” 100 (i.e. three toe paw) with the colour FRAs of the factors/numerals “6” 21 (i.e. yellow 22), “7” 23 (i.e. red 24), “8” 25 (i.e. blue 26) and “9” 27 (i.e. white 28) as follows:
1. 3×6 is represented by colouring the FRA, three toe paw 101 with the FRA, yellow 22 to derive the FORA, yellow three toe paw 41;
2. 3×7 is represented by colouring the FRA, three toe paw 101 with the FRA, red 24 to derive the FORA, red three toe paw 42;
3. 3×8 is represented by colouring the FRA, three toe paw 101 with the FRA, blue 26 to derive the FORA, blue three toe paw 43;
4. 3×9 is represented by colouring the FRA, three toe paw 101 with the FRA, white 28 to derive the FORA, white three toe paw 44;

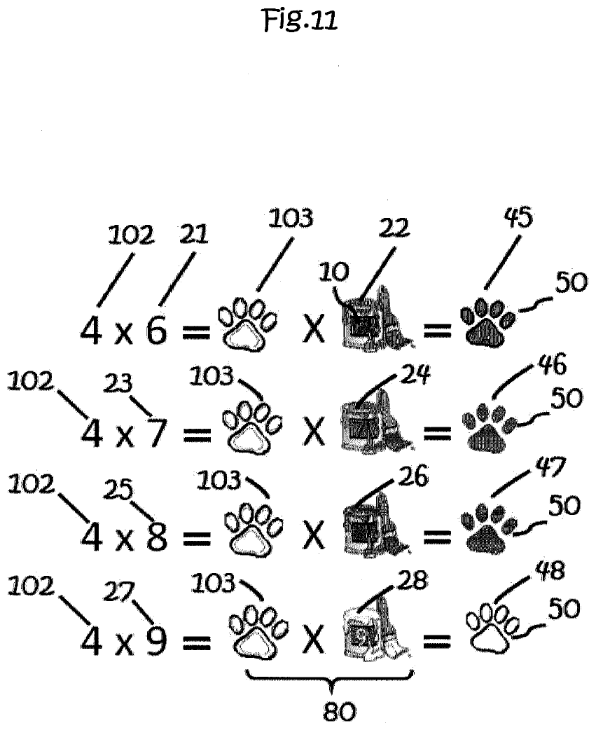

With reference to FIG. 11, each numerical factor operation (and its product) aligns with a derived factor operation representation attribute (FORA) based on a non-numerical factor operation 80 comprising colouring the factor representation attributes (FRAs) for the factor/numeral “4” 102 (i.e. four toe paw) with the colour FRAs of the factors/numerals “6” 21 (i.e. yellow 22), “7” 23 (i.e. red 24), “8” 25 (i.e. blue 26) and “9” 27 (i.e. white 28) as follows:
1. 4×6 is represented by colouring the FRA, four toe paw 103 with the FRA, yellow 22 to derive the FORA, yellow four toe paw 45;
2. 4×7 is represented by colouring the FRA, four toe paw 103 with the FRA, red 24 to derive the FORA, red four toe paw 46;
3. 4×8 is represented by colouring the FRA, four toe paw 103 with the FRA, blue 26 to derive the FORA, blue four toe paw 47;
4. 4×9 is represented by colouring the FRA, four toe paw 103 with the FRA, white 28 to derive the FORA, white four toe paw 48.

The colour attribute of each of the factor operation representations 50 is shared as a colour attribute of each of the corresponding solution representations 60 as shown in FIG. 12. Further, as shown for the solution representation 60e entitled “Yellow BEAN”, the factor operation representation 41 (yellow three toe paw) is also placed proximal to, or integrated as part of the solution representation, which also comprises a spider 67, a yellow bean 68 and the title attribute “Yellow BEAN” 96. This solution representation is then decoded to uncover the term for the numerical solution “18” (eighteen) to the factor operation “3×6” by counting the legs of the spider 67 to decode the first syllable of the word for the solution and then using the rhyme association between “BEAN” and “teen” to decode the second syllable to obtain “eighteen”. This process can be similarly repeated for the other solution representations in FIG. 12.

With reference to FIG. 13, the solution representation entitled “Yellow STORE”, the factor operation representation 45 (yellow four toe paw) is placed proximal to, or integrated as part of the solution representation 60f, which also comprises two cats 69, a yellow store 70 and the title attribute “Yellow STORE” 97. This solution representation is then decoded to uncover the numerical solution “24” to the factor operation “4×6” by counting the two cats 69 to decode the numeral “2” (ten place value) and using the rhyme association between “STORE” and “four” to decode the numeral “4” (one place value) of the solution. This process can be similarly repeated for the other solution representations in FIG. 13.

An additional decoding aid in the form of a story vignette can be used (conveyed in writing, or audibly conveyed) to provide clues as to the solution, or as a means to verify the solution, for example:
Numbers 4 and 6 for Yellow STORE/2 Cats

### Cats go Shopping

It was a hot summer day. The house was quiet because most of the six cats were asleep. Two cats decided to go shopping at the YELLOW Store. By the time they arrived at the YELLOW Store they were tired. They found a sign that said “Cold Water”. They decided to buy bottles of water, four bottles for each cat. The two cats bought four bottles for each of the six cats, from the YELLOW Store.

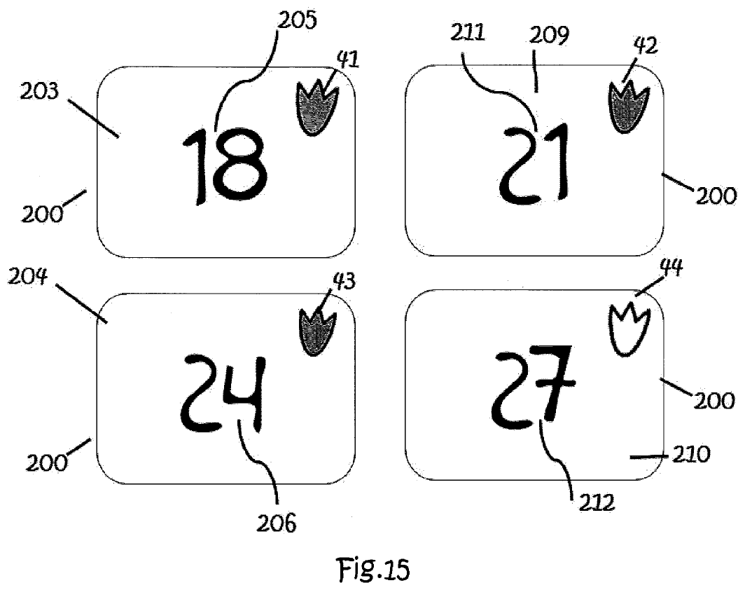

In one embodiment of the system according to the disclosure, factor operation representations are tangibly depicted on both sides of a set of flip cards 200 where one side has the solution representations (see FIG. 14) and the other side has the corresponding numerical solutions/products depicted (see FIG. 15). For example, sides 201, 202, 207 and 208 of FIG. 14 provide the solutions representations seen in FIG. 12 and sides 203, 204, 209 and 210, respectively, depict the solutions “18” 205, “24” 206, “21” 211 and “27” 212 in FIG. 15 corresponding to the solution representations of FIG. 14 based on matching the factor operation representations. Instead of flip cards the two sides can be provided as two decks of cards for performing the matching operation.

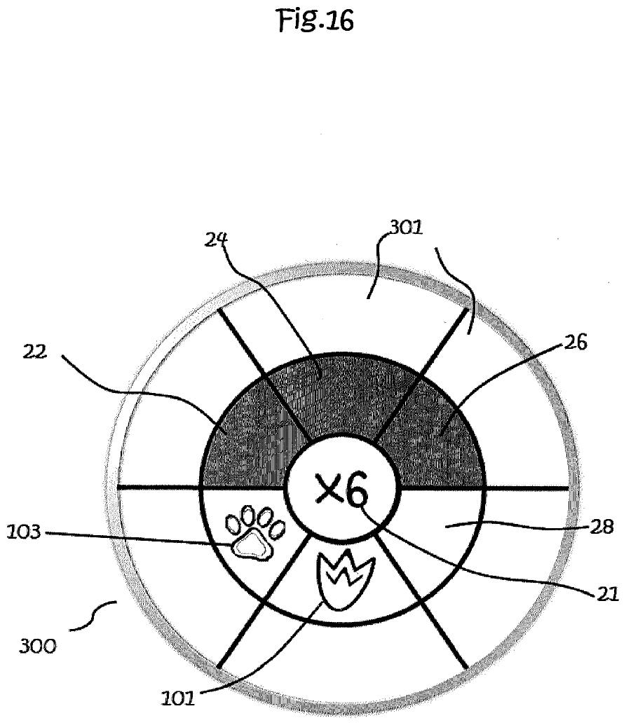

As a way to practice the application of the systems and methods of the present disclosure a learning wheel 300 is provided as exemplified in FIG. 16, including the numerical factor “6” 21 in the center to be multiplied with the surrounding factor representations yellow 22, red 24, blue 26, white 28, three toe paw 101 and four toe paw 103 surrounding it to derive the corresponding factor operation representations. For example, to obtain and record the factor operation representation for the numerical and non-numerical factor operation “6×yellow” the learner can first correlate the factor representation yellow as shown in FIG. 1 to the factor “6”, and then perform the methods described in Examples 1 and 2 to derive and place, draw, or apply the colour and image attributes (as applicable) of the factor operation representations in the spaces 301 around the wheel 300.

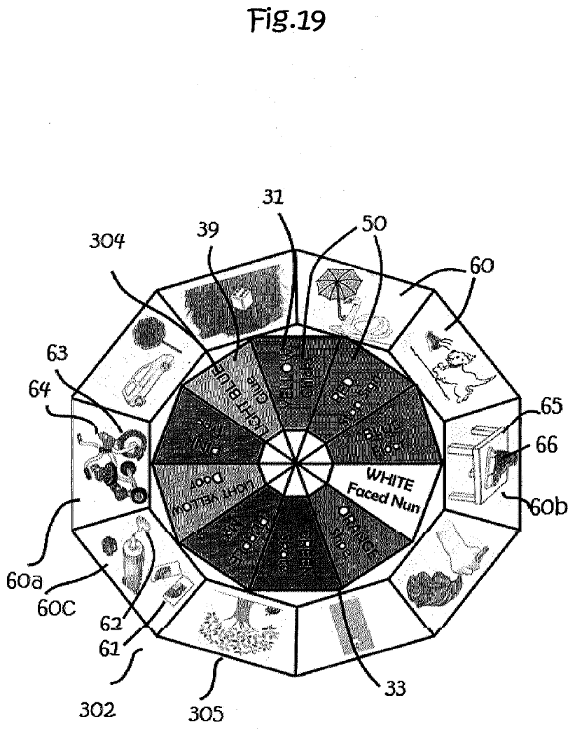

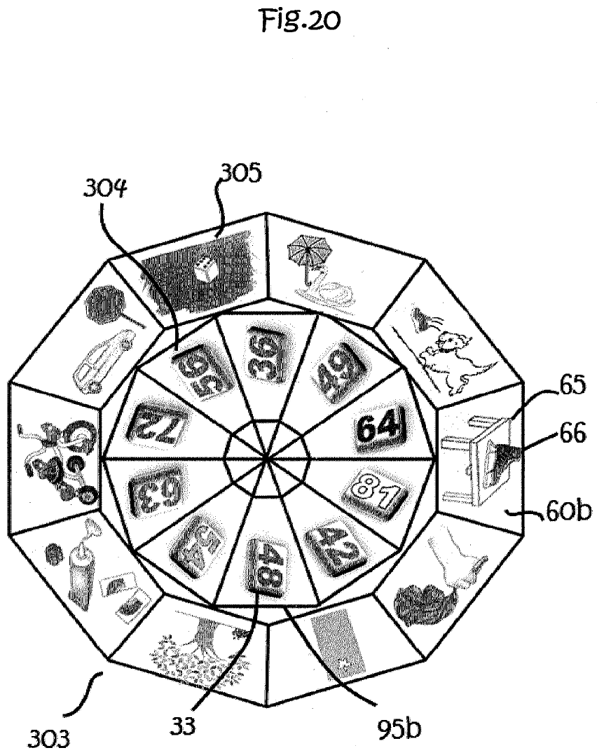

An alternative single learning wheel or system of learning wheels can be designed as a learning aid for decoding the numerical solution from solution representations when performing both multiplication and division operations, as shown in FIGS. 19-21. The design of wheels 302 and 303 is to have an inner wheel portion 304 and outer wheel portion 305, which portions may or may not be turned relative to one another for alignments to be made based on the application of the systems and methods of the present disclosure (see FIGS. 19 and 20).

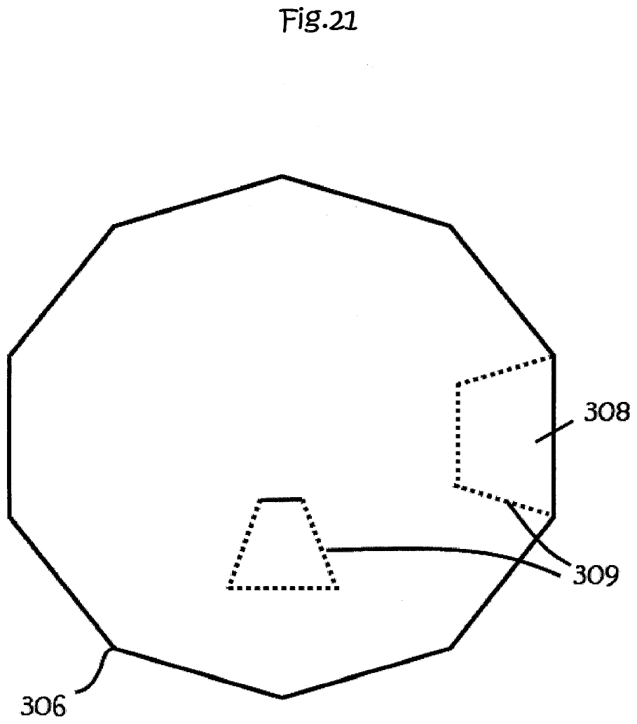

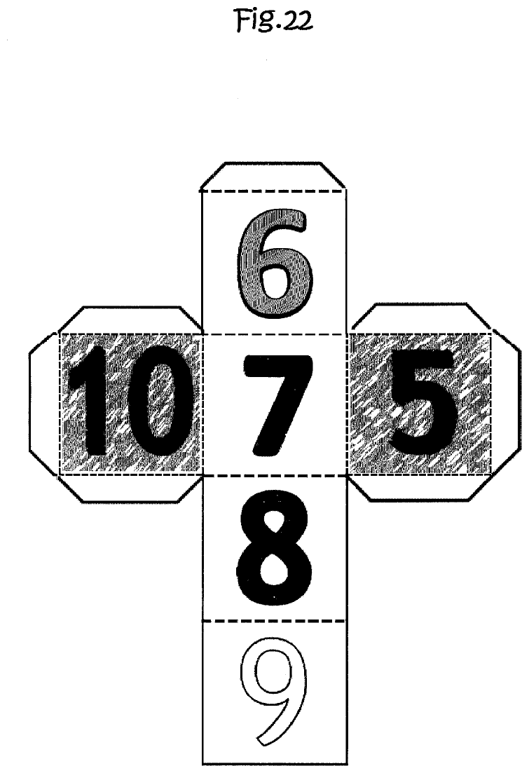

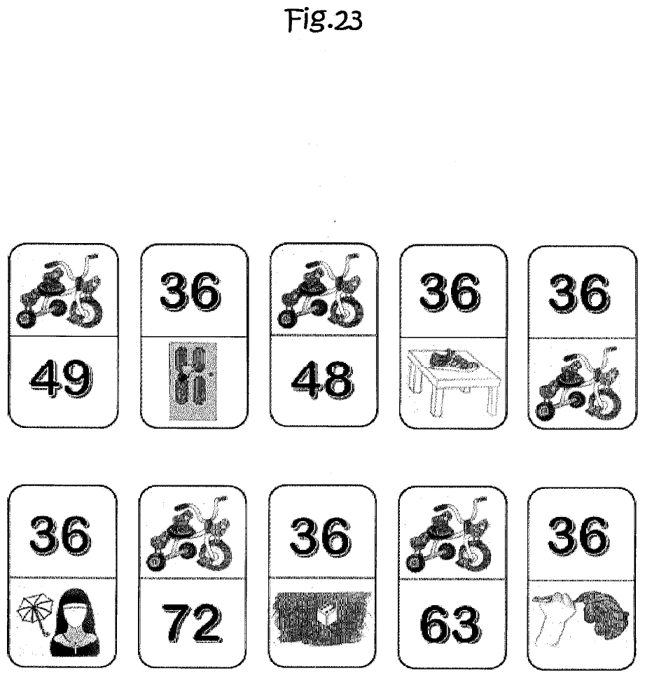

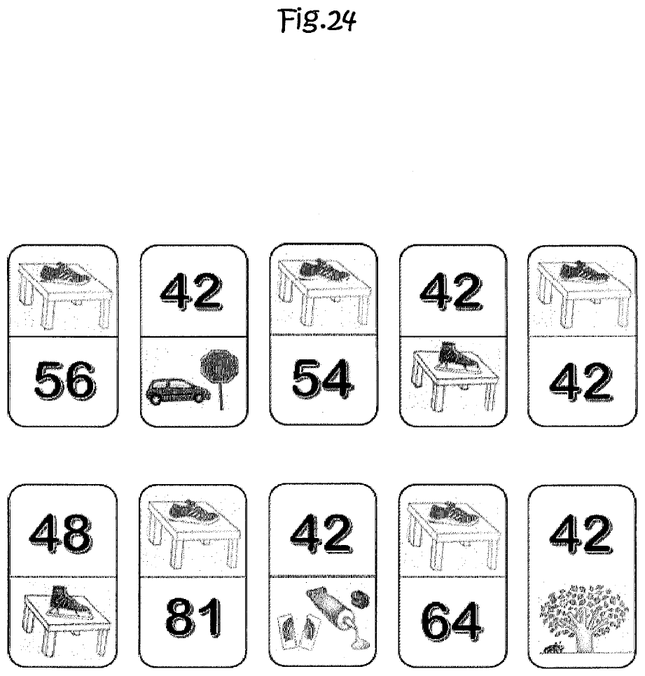

In the case of a wheel 303 configuration where the inner portion 304 and outer portion 305 do not move relative to one another, FIG. 21 provides an add on or third wheel portion 306 with cut out windows 307 and 308 shaped to reveal a section of the inner wheel portion 304 and outer wheel portion 305, respectively. This third wheel portion 306 can be overlaid on top of either wheel 303 shown in FIGS. 19 and 20 and turned to isolate for viewing the factor operation representation corresponding to a given solution representation. For example, overlaying the third wheel portion 306 on top of the wheel portions 304 and 305 in FIG. 19 will reveal the factor operation representation entitled “GREEN Skate” with the colour attribute green 33 in window 307 and the solution representation image of the green skate 66 and table 65 in the window 308. The windows 307 and 308 of the third wheel portion 306 may also have flaps 309 as indicated by the dotted lines representing the movable edges of the flaps to hide and reveal what can be viewed through windows 307 and 308.

As noted above, FIG. 19 exemplifies a wheel tool 302 where the inner wheel portion 304 has a series of factor operation representations/attributes 50, which correlate to the solution representations 60 of the outer wheel portion 305. For example, attribute 31 of factor representation 50 is shared with attribute 64 of solution representation 60a. Upon decoding a solution representation to obtain the product of a multiplication factor operation using wheel 302, a learner may then use wheel 303 shown in FIG. 20 to decode the solution of a division operation. After decoding the product “48” 95b using wheel 302 from the solution representation 60b a learner is then able to use wheel 303 to work backwards from the product “48” (now the dividend), coloured with the factor operation representation attribute “green”. Given a divisor selected from one of the two factors in the multiplication operation “6×8”, the learner can refer to the shared colour attribute between the solution representation 60b and factor operation representation attribute 33 to discover the quotient to the division operation. If the learner is asked to solve the division operation “48±8” the learner will know the colour green is the attribute 33 of the factor operation representation derived by mixing the factor representation attributes “blue” and “yellow” (as shown in FIG. 2). Having previously correlated the factor representation “blue” with the number “8” and the factor representation “yellow” with the number “6”, the learner can obtain the quotient “6” by a process of elimination.

### Example 3: Exemplary Combination System and Method for Multiplication and Division of Numerals 6, 7, 8, and 9

The system and method according to the present disclosure may be combined with other approaches for teaching and learning multiplication and division. The objective for doing so is to provide learners with additional options for using different cognitive pathways for teaching and learning multiplication using sensory (e.g. visual, auditory, and/or kinesthetic) reinforcement means.

A design consideration for combining systems and methods of teaching and learning multiplication and division is to identify whether an alternative system and method engages compatible cognitive processing pathways as a particular embodiment of the presently disclosed system and method. In the following exemplary embodiment, the system and method of the present disclosure is combined with an alternative system and method that also applies surrogate expression means for problem solving a factor operation.

### Alternative System and Method for Multiplication and Division of Numerals 6, 7, 8, and 9

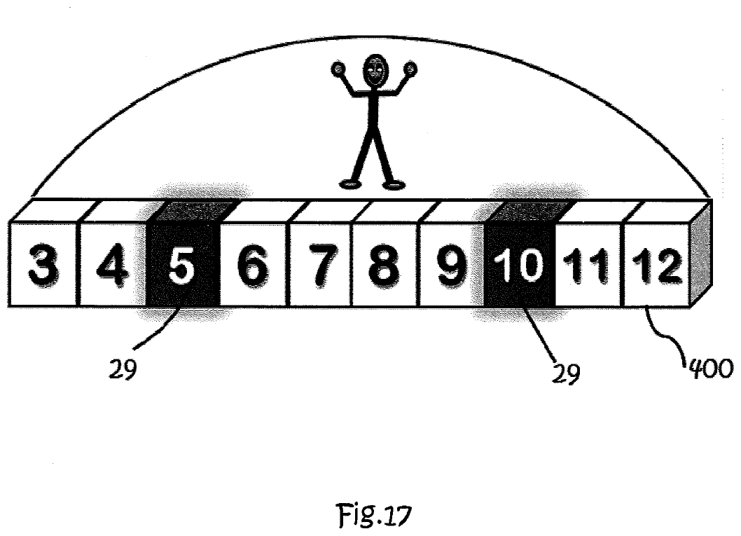

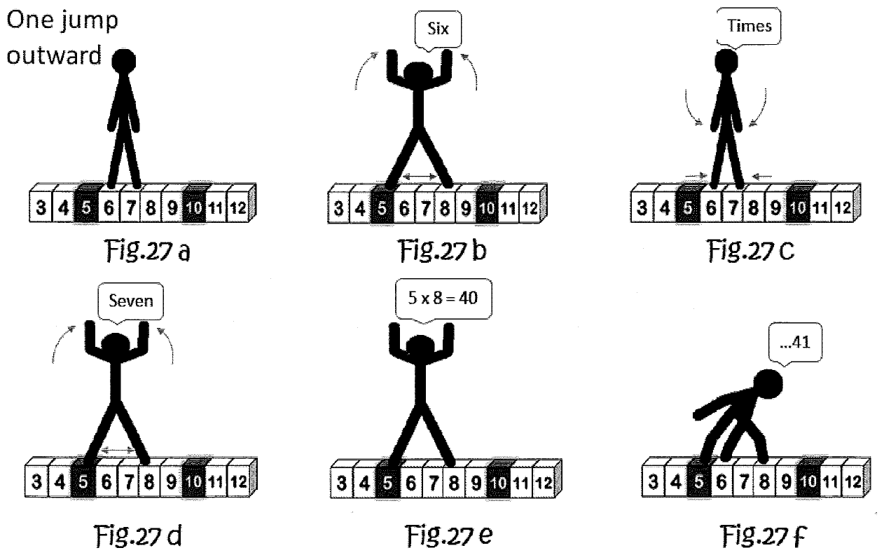

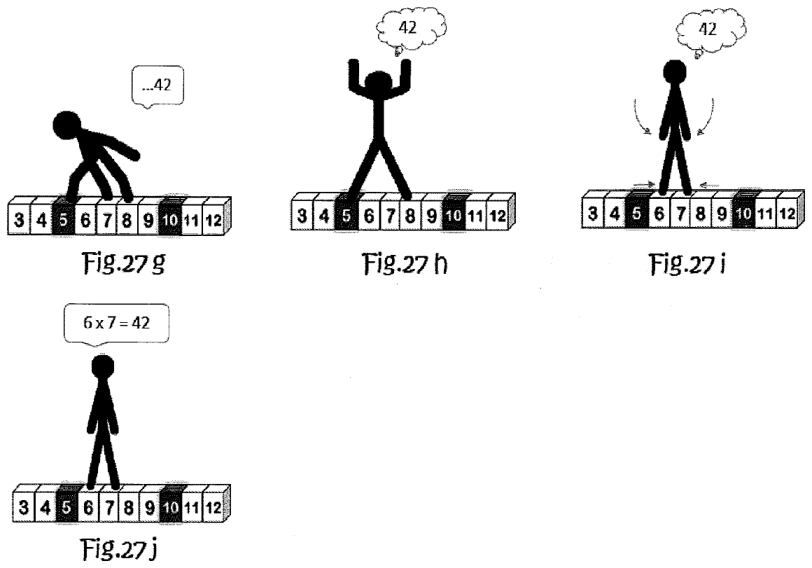

An alternative approach to learning the multiplication and division of two factor operations for numerals ranging between “3” and “12” is the system and method depicted in FIG. 17, and FIGS. 27-30. With reference to FIG. 17, the system and method are designed so that learners derive the product of a selected two-factor multiplication operation (that does not include the numerals “5” and/or “10” by working from another multiplication operation that does include the number values “5” and/or “10”, and then performing an addition or subtraction adjustment to get at the answer (product) to the selected multiplication operation. The application of a two-factor multiplication operation (new operation) with the numeral(s) “5” and/or “10” with the addition or subtraction of an adjustment create a numerical surrogate expression (operation) for the subject operation.

More particularly, learners use an educational device (displaying a numbered track 400) and apply a series of operations using their mastery of multiplication operations involving the numbers “5” and “10” to solve multiplication and division operations when the multipliers, divisors and quotients are in the range of numbers from “3” to “12”, but other than “5” and/or “10”. The educational device displaying the numbered track 400 distinguishes the numerals “5” and “10” by giving the expression of each of these numerals in their boxes a colour attribute 29 (e.g. black) different from the colour attributes of the other factors along the track.

This system and method shown in more detail in FIGS. 27-30 is represented as a series of steps that can be carried out using visual, auditory and kinesthetic cues to help learners solve two factor multiplication operations for factors from “3” to “12”. The steps involve the use of a teaching aid device, such as a track on a mat, and proceed in sequence by selecting a two factor operation that does not include the factor(s) “5” and/or “10”, discovering the answer (product/solution) beginning with a factor operation that includes the factor(s) “5” and/or “10”, followed by applying a set of rules to make an adjustment using addition and subtraction operations.

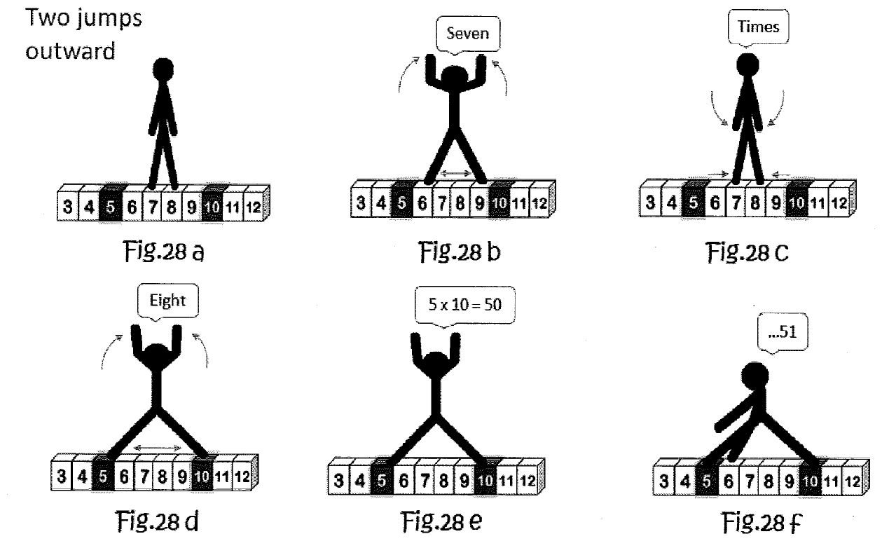

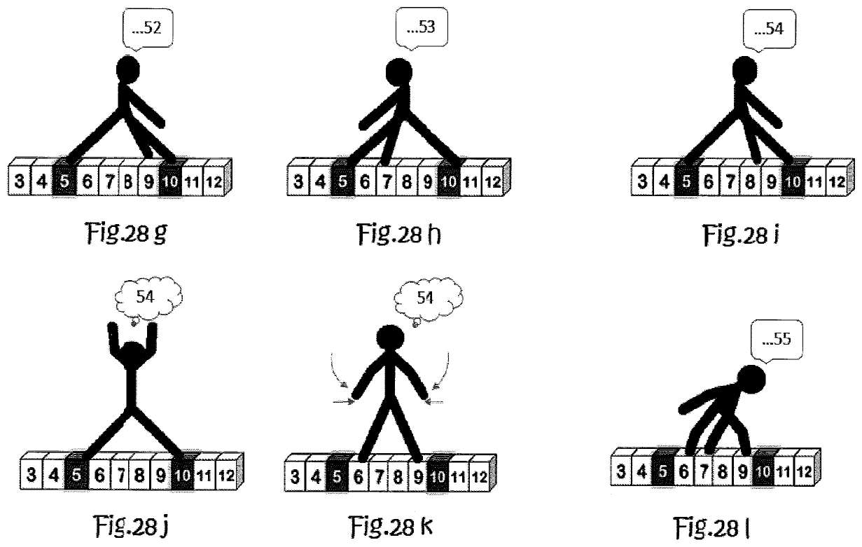

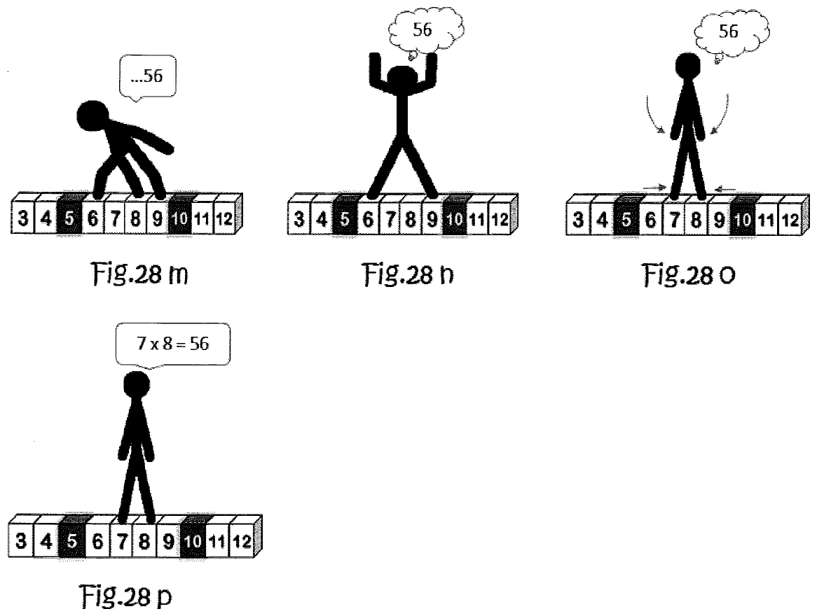

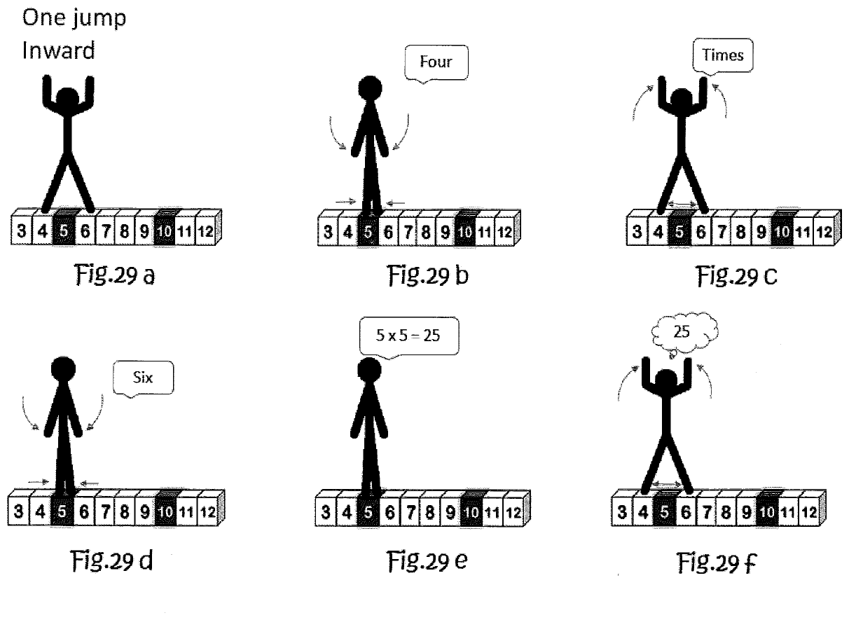

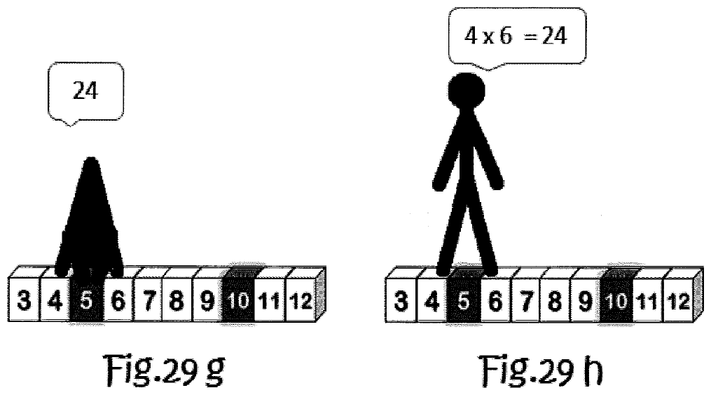

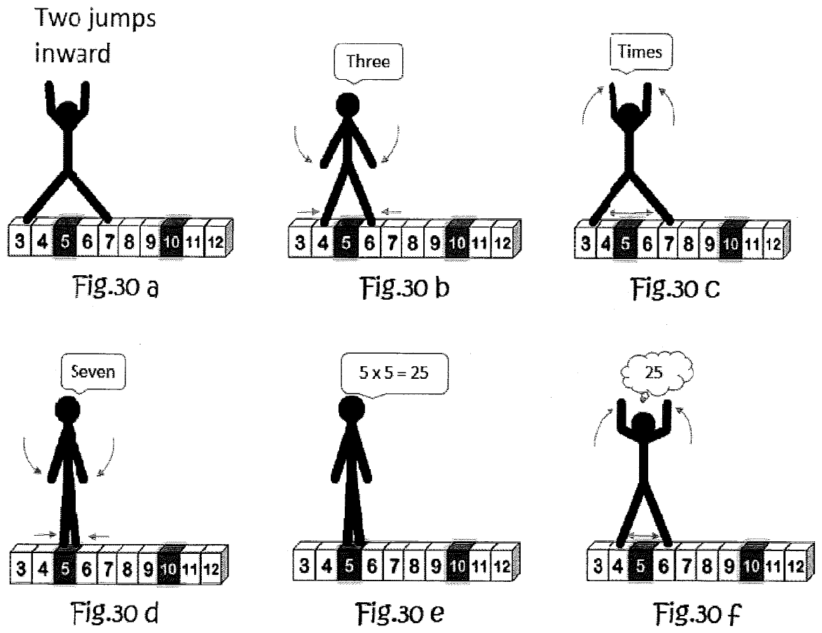

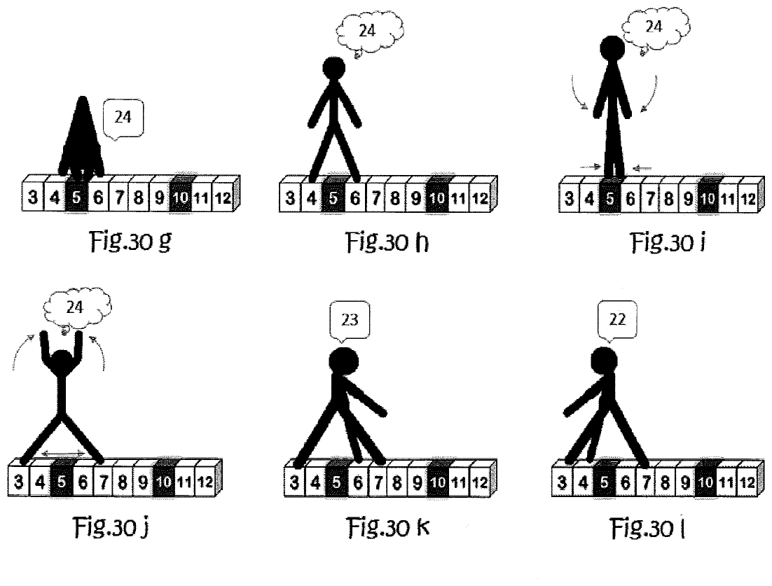

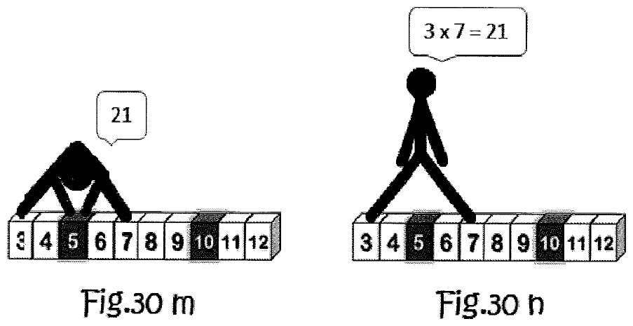

FIGS. 27-30 present the four general possible set of movements and visual processing steps to represent and solve multiplication and division operations using the alternative system and method for multipliers (factors), divisors and quotients in the range of numbers from “3” to “12”. The methods shown involve a learner: (i) moving one step outward in both directions on the track from the subject operation to get the new multiplication operation that includes the factors “5” and/or “10” (FIG. 27a to 27b, or 27c to 27d); (ii) moving two steps outward in both directions on the track from the subject operation to get the new multiplication operation that includes the factors “5” and/or “10” (FIGS. 28a to 28b, or 28c to 28d); (iii) moving one spot inward in both directions on the track from the subject operation to get the new multiplication operation that includes the factors “5” and/or “10” (FIGS. 29a to 29b, or 29c to 29d); (iv) moving two spots inward in both directions on the track from the subject operation to get the new multiplication operation that includes the factors “5” and/or “10” (FIGS. 30c to 30d).

In the examples shown in FIGS. 27-30 for various two-factor operations, learners stand on a numbered track on the floor (e.g. using a mat or projected light image) and place each foot on the number values corresponding to each of the factors of the multiplication operation that does not include the factor(s) “5” and/or “10”. By default, the left foot will be placed on the lower number value and the right foot on the greater number value, or both feet on the same number value (with the number values in the track facing toward the learner). This way the system itself takes care of the duplications. Learners are taught to read the math fact (multiplication operation) beginning with the lowest number.

To get the answer for a given multiplication operation, the learner will physically move one or two spots outward or inward with both feet until at least one foot lands on a spot with the numerical value of “5” and/or “10” of the numbered track. For engagement purposes, the learner may perform ‘jumping-jack’-like movements saying out loud the factor operation that is the subject of the exercise, e.g. “6×7” as shown in FIGS. 27a-27d. This results in the left foot being placed on the value corresponding to one unit less and the right foot on one unit more on the numbered track than the starting (original) positions for each foot (FIGS. 27a to 27b and FIGS. 27c to 27d). When a learner jumps inward, the movements are reversed for each foot (FIGS. 27b to 27c).

Once a jump moving outward or inward ends up landing on a numerical value of “5” and/or “10” with at least one foot, the numerical values under each foot represent each of the factors of the new multiplication operation (surrogate expression/representation) to be used to solve the subject (starting) factor operation. Using the example shown in FIG. 27, this becomes the operation “5×8” (FIG. 27d) for the subject operation “6×7” (FIG. 27a).

When jumping outward one or two times to end up landing over the numerical values “5” and/or “10”, the adjustment will be adding to the product of the new multiplication operation, the number of values between the feet on the numbered track, after the jump to the numerical values “5” and/or “10”, to get the product of the given subject (multiplication) operation.

When jumping inward one or two times to end up landing over the numerical values “5” and/or “10”, the adjustment will be subtracting from the product of the new multiplication operation, the number of values between the feet on the numbered track before the jump to the numerical values “5” and/or “10”, to get the product of the given subject (multiplication) operation.

Division operations are taught and learned as a consequence of mastering multiplication.

In one variation, the system comprises a numbered track with numerals “3” to “12” and additional components selected from flip or flashcards, spinners/wheels and dice to randomly select the multiplication facts (operations).

The numbered track can be made to be displayed in the form of a physical object, such as a mat, tiles, blocks and ruler made from any suitable material, such as vinyl, plastic, foam, cardboard, wood, and paper.

In general, when a physical numbered track on the floor is used to engage a learner to use his/her feet and/or hands is displayed on the floor, the dimensions can be adapted for learners of different sizes, such as children (e.g. grade two to four level) to be able to place their feet on it and perform the outward or inward movements according to the method. Alternatively, the system's numbered track can be displayed using light projection on a video (interactive) display/screen, on a wall or on a floor. In the case of a ruler, the learner will use finer motor skills with his/her fingers instead of the legs and/or hands to place them on the ruler's numbers (as factors) to perform the operations of the method.

To reinforce the learning process, the visual and kinesthetic steps taken along the track can also be performed audibly to help a learner calculate and remember the adjustment to be made between the product of the new operation and the product of the related subject operation by way of moving outward or inward along the track.

The most complete form of performing the method associated with the disclosed device consists of the following steps:

To more specifically illustrate the approach of the alternative approach described above, methods for solving multiplication operations according to the present disclosure are further exemplified with reference to the figures.

FIG. 27 (27a-27j) exemplifies the steps of a method to solve the subject operation “6×7” using movement and/or vocalizations along with the visual cues provided by the numbered track. A learner places each foot on the factors on the numbered track (FIG. 27a) and then moves each foot outward (e.g. by doing a ‘jumping-jack’-like movement), while saying or not saying out loud “six times seven” according to a rhythm that may result in doing the movement once or twice, as shown in FIGS. 27b-27d. The movement outward results in the placement of a foot on the numerals “5” and “8” (in this case by one step in both directions along the numbered track), for the learner to identify the new multiplication operation “5×8”, and then apply his/her knowledge of multiplication operations using the factor “5” to solve the new operation (FIG. 27e). The learner has the option to verbalize out loud “five times eight equals forty” (“5×8=40”).

The learner will then add an adjustment to the solution “40” equivalent to the number of spaces or numerals between his/her feet, having the option to bend down and touch the numerical values between his/her feet (i.e. the numbers “6” and “7” in this case) one at a time counting up. In doing so, the learner counts (optionally saying out loud) “forty-one” (“41”) while touching number “6” with the right hand (FIG. 270, and then “forty-two” (“42”) while touching the number “7” with the left hand (FIG. 27g), for a total adjustment of two (“40+2=42”). The learner can either vocalize “forty-two” (“42”) as the solution to the subject operation (FIG. 27h) and/or exercise the option to move (e.g. jump) inward one step with each foot to return to the original starting position and repeat “six times seven equals forty-two” (“6×7=42”) (FIGS. 27i and 27j).

FIG. 28 (28a-28p) exemplifies the steps to solve the operation “7×8” using movement and/or vocalizations along with the visual cues provided by the numbered track. A learner places each foot on the factors on the numbered track (FIG. 28a) and then moves each foot outward (e.g. by doing a ‘jumping-jack’-like movement), while saying or not saying out loud “seven times eight” according to a rhythm that results in doing the movement twice in a step-wise manner, as shown in FIGS. 28b-28d. Once the movement outward results in the placement of a foot on the numerals “5” and “10” (in this case by a total of two steps in both directions along the numbered track) to identify the new multiplication operation “5×10”, the learner can apply his/her knowledge of multiplication operations using the factor(s) “5” and/or “10” to solve the new operation (FIG. 28e). The learner has the option to verbalize out loud “five times ten equals fifty” (“5×10=50”).

The learner will then add an adjustment to the solution “fifty” (“50”) of the new operation, having the option to bend down and touch the numerical values between his/her feet (i.e. the numbers “6, “7”, “8” and “9” in this case) and option to vocalize each step to arrive at an initial adjustment. That is, the learner counts up, one at a time, to “fifty-one” (“51”), while touching number “6” with the right hand (FIG. 28f), to “fifty-two” (“52”), while touching the number “9” with the left hand (FIG. 28g), to “fifty-three” (“53”), while touching the number “7” with the right hand (FIG. 28h) and to “fifty-four” (“54”), while touching the number “8” (FIG. 28i), for a total initial adjustment of “four” (“50+4”) to arrive at “54” (FIG. 28j). Moving another step inward in both directions to place the feet on numerals “6” and “9” (FIG. 28k), the learner continues the adjustment determination using the right and left hands to touch the numerals “7” and “8”, for an additional adjustment of “two”, and a total adjustment of “six” (“50+4+2=56”) as shown FIGS. 28l and 28m. The learner can either vocalize “fifty-six” (“56”) as the solution to the subject operation (FIG. 28n), or exercise the option to move (e.g. jump) inward one step with each foot to return to the original starting position and repeat “seven times eight equals fifty-six” (“7×8=56”) (FIGS. 28o and 28p).

FIG. 29 (29a-29h) exemplifies the steps to solve the operation “4×6” using movement and/or vocalizations along with the visual cues provided by the numbered track. A learner places each foot on the factors on the numbered track (FIG. 29a) and then moves each foot inward (e.g. by doing a ‘jumping-jack’-like movement), while saying or not saying out loud “four times six” according to a rhythm that may result in doing the movement once or twice, as shown in FIGS. 29b-29d. Once the movement inward results in the placement of both feet on the numeral “5” to identify the new multiplication operation “5×5” (in this case by one step in both directions along the numbered track), the learner can apply his/her knowledge of multiplication operations using the factor “5” to solve the new operation (FIG. 29e). The learner has the option to verbalize out loud “five times five equals twenty-five” (“5×5=25”).

The learner will then add an adjustment to the solution “25” equivalent to the number of spaces or numerals between his/her feet, before moving them inward. This can be recalled by moving the feet outward again by a step in each direction (FIG. 290, and then having the option to bend down and touch the numeral “5” with both hands, subtracting “one” from “twenty-five” (“25−1=24”) to obtain the solution “24” to the subject operation (FIG. 29g). The learner can then optionally vocalize the subject operation and its solution “4×6=24” as shown in FIG. 29h.

FIG. 30 (30a-30n) exemplifies the steps of a method to solve the operation “3×7” using movement and/or vocalizations along with the visual cues provided by the numbered track. A learner places each foot on the factors on the numbered track (FIG. 30a) and then moves each foot inward (e.g. by doing a ‘jumping-jack’-like movement), while saying or not saying out loud “three times seven” according to a rhythm that results in doing the movement twice in a step-wise manner, as shown in FIGS. 30b-30d. Once the movement outward results in the placement of both feet on the numeral “5” to identify the new multiplication operation “5×5” (in this case by a total of two steps in both directions along the numbered track), the learner can apply his/her knowledge of multiplication operations using the factor “5” to solve the new operation (FIG. 30e). The learner has the option to verbalize out loud “five times five equals twenty-five” (“5×5=25”).

The learner will then subtract an initial adjustment from the solution “25” equivalent to the number of spaces or numerals between his/her feet, before moving them inward. This can be recalled by moving the feet outward again by a step in each direction (FIG. 300 to rest on the numerals “4” and “6”, and then having the option to bend down and touch the numeral “5” with both hands, subtract “one” from “twenty-five” (“25−1”) to arrive at “24” (FIG. 30h). This initial adjustment is followed by the determination of a further adjustment made by again moving each foot outward (with or without an intervening ‘jumping jack’-like movement) from numeral “5”, as shown at FIG. 30i, to rest on the numerals “3” and “7”, the original starting position for the subject operation (FIG. 30j). The learner will then countdown (subtract) the additional adjustment, having the option to bend down and touch the numerical values between his/her feet (i.e. the numbers “4, “5”, and “6” in this case) and option to vocalize each step. That is, the learner counts down, one at a time to “twenty-three” (“23”), while touching number “6” with the right hand (FIG. 30k), to “twenty-two” (“22”), while touching the number “4” with the left hand (FIG. 30l), and to “twenty-one” (“21”), while touching the number “5” with both hands (FIG. 30m), for an additional adjustment of “three” (“3”) and total adjustment of “four” (“25−1−3=21”) (FIG. 30n).

It will be evident to one skilled in the art that the movement choreography described above for the numbered track system and method can be accomplished in different sequences or variations so long as the basic movement sequences outward and inward from the new operation numerals back to the subject operation are performed in the correct direction and in a step wise manner to make incremental and total adjustment determinations. For example, the counting up or counting down with a two-step adjustment the learner can use the same arm to touch each of the numerals between the feet, use both arms in a different sequence, or otherwise touch the numerals in between the feet in a different sequence or order.

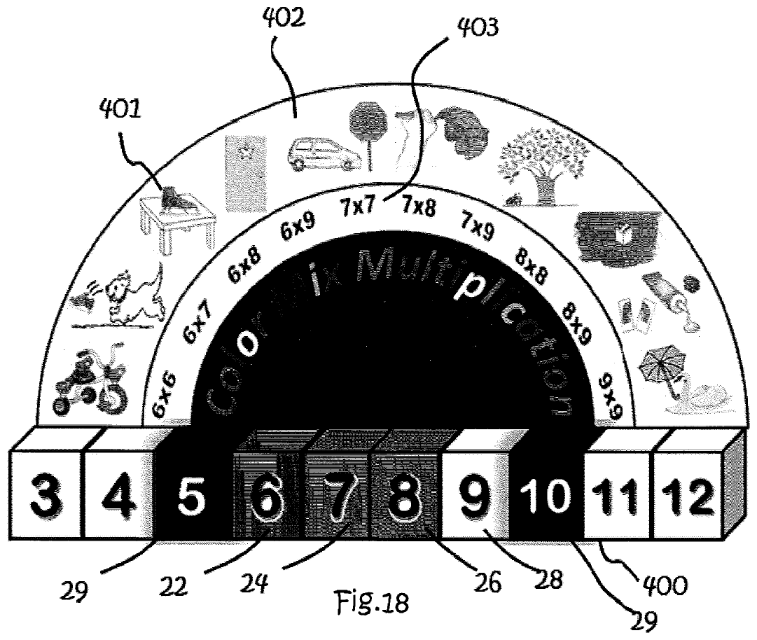

To combine the numbered track system and method of FIG. 17 with the system and method of the present disclosure, a visual integration of the features of the two systems and methods is provided in FIG. 18 where the numbered track 400 has been provided with a revised colour scheme to reflect the colour attributes of the factor representations for the numerals “6” (yellow), “7” (red), “8” (blue) and “9” (white) described in Example 1. The corresponding solution representations for the indicated factor operations are presented in a two-layer semi-circle 401 arrangement spanning the numbered track 400 where the factor operations are shown in layer 403 and the solution representations are shown in layer 402.

To use the combination system, a mat device or computer driven display of FIG. 18 is provided to the learner who can then apply either or both systems and methods for learning multiplication and division for factors ranging between “3” and “12”. Working with the specific combination configuration of FIG. 18 the learner is provided with reinforced learning opportunities for factor operations using the numerals “6”, “7”, “8” and “9”. The learner works with the factor representations along the numbered track 400 for the indicated factor operations in layer 403 to derive the colour attribute of the corresponding factor operation representations and thereby identify and decode the corresponding solution representation in layer 402. The learner then has the opportunity to check the answer obtained using the system and method of the present disclosure using the alternative system and method according to, or analogous to FIGS. 27 and 28. The order of using one system and method are also interchangeable according to the learner's preferences.

### Example 4: Exemplary Light Display System and Method for Multiplication with Numerals 6, 7, 8, and 9 Incorporating Movement

The system and method of the present disclosure may be provided and executed using light projection technologies (e.g. see U.S. Pat. No. 9,241,124; Lumo Play Inc.), which provide opportunities for interactive learning.

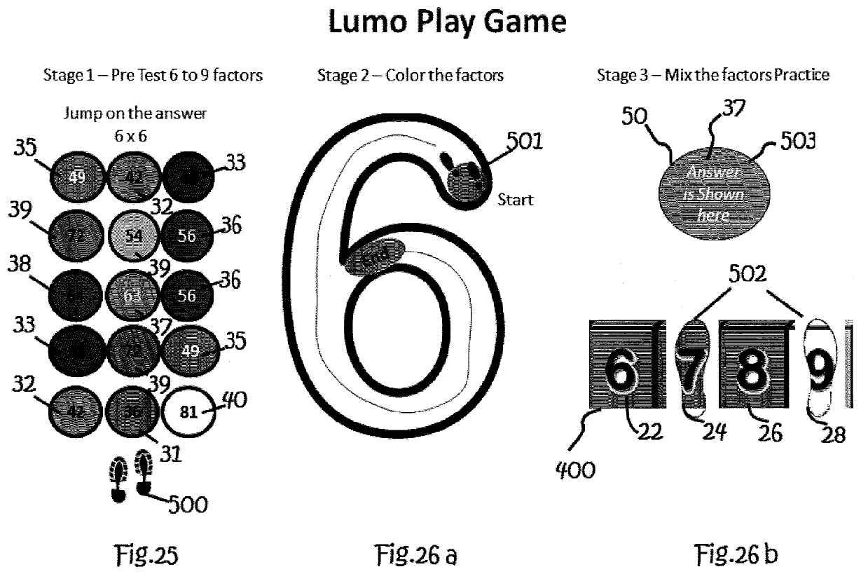

In one exemplary embodiment incorporating the system and method exemplified in Example 1, the numerals, factor operations and various non-numerical representations may be displayed using light projection on a floor. The configuration for such an exemplary system and method optionally provides a pre-test image projection (FIG. 25) to allow the learner to test his/her knowledge standing at starting position 500 and then move to the product circle corresponding to the factor operation displayed (in this case “6×6”). Based on the learner's experience with the pre-test of FIG. 25, the learner can decide which factor operations to work on, while at the same time becoming familiar with the distinctive colour attributes of the factor operation representations and their associated numerical products/solutions.

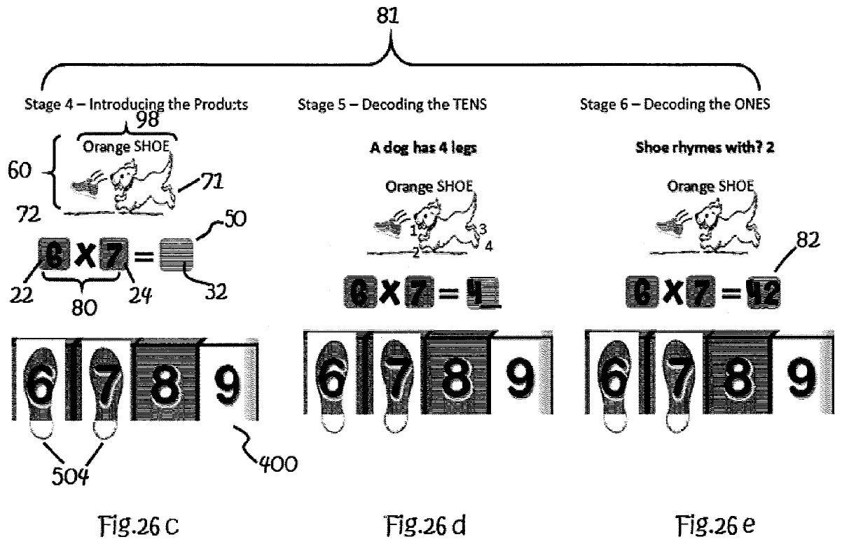

With reference to FIG. 26 (26a-26e), the learner then physically engages the aspects of the system and method of the present disclosure for identifying the non-numerical factor representations at Stage 2, e.g. “yellow” for the factor “6”, by stepping onto position 501 of a projected floor image and moving along the contour of the number to reveal the applicable colour attribute of the factor representation, as the system registers the learner's movement (FIG. 26a).

In Stage 3, the learner working with the exemplary factor operation “7×9” derives the factor operation representation 50 at position 503 with the colour attribute 37 by stepping at position 502 along a projected number track 400.

Stages 4 to 6 (exemplified working with the factor operation “6×7” follows from the learner standing at position 504 of the numbered track 400. The factor representations overlaid with the numerical factors are shown as a complete equation with the colour attribute 32 of the factor operation representation 50 and the corresponding solution representation 60e with the title attribute “Orange SHOE” 98 (FIG. 26c). By mixing/blending the colour attributes “yellow” 22 and “red” 24 of the non-numerical operation 80 to derive the colour attribute 32 of the factor operation representation 50, the learner can then decode the solution representation 60e. First the learner decodes the tens place value numeral of the solution by counting the number of legs (“4”) on the dog (attribute 71; FIG. 26d) and then decodes the ones place value of the numerical solution by correlating the sound of “Orange SHOE” (attribute 72) to the numeral “2” for a numerical solution 82 of “42” (FIG. 26e).

The projection of the images for performing Stages 1 to 6 can all be on the floor or distributed onto different surfaces or displays. For example, the numbered track 400 can be displayed on the floor and Stages 4 to 6 can be executed interactively on the floor, on a wall, or on a video display monitor/screen in front of where the learner is standing using his/her hands, or a pointing tool. Other configurations can also apply holographic imaging, virtual reality technologies when implementing the system and method of the disclosure using light projection.

The invention has many different features, variations and multiple different embodiments. The invention has been described in this application at times in terms of specific embodiments for illustrative purposes and without the intent to limit or suggest that the invention conceived is only one particular embodiment. It is to be understood that the invention is not limited to any single specific embodiments or enumerated variations. Many modifications, variations and other embodiments of the invention will come to mind of those skilled in the art to which this invention pertains, and which are intended to be and are covered by both this disclosure. It is indeed intended that the scope of the invention should be determined by proper interpretation and construction of the disclosure, including equivalents, as understood by those of skill in the art relying upon the complete disclosure at the time of filing.

The disclosures of all patents, patent applications, publications and database entries referenced in this specification are hereby specifically incorporated by reference in their entirety to the same extent as if each such individual patent, patent application, publication and database entry were specifically and individually indicated to be incorporated by reference.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

1-35. (canceled)

36. A system for teaching or learning multiplication and division comprising one or more physical devices having fixed thereon non-numerical representations for numerals and numeric operations, each of said non-numerical representations being distinguishable from the other non-numerical representations by one or more attributes to provide:
i. a factor representation for each numerical factor of a selected factor operation having a numerical solution;
ii. a factor operation representation for the factor operation, derivable by performing a non-numerical operation using one or more of the one or more attributes of each of the factor representations to derive one or more attributes of the factor operation representation; and
iii. a solution representation encoding the numerical solution to the factor operation, comprising a shared attribute in common with the factor operation representation that is derived by performing the non-numerical operation, wherein each numeral in the numerical solution is encoded by a distinct attribute of the solution representation.

37. The system of claim 36, wherein the system further comprises instructions for:
i. recognizing each numerical factor based on the one or more attributes of each factor representation;
ii. applying the non-numerical operation to the factor representations to derive the factor operation representation of the factor operation;
iii. correlating the factor operation representation to the solution representation with reference to the shared attribute; and
iv. decoding the solution representation with reference to its one or more attributes to determine the numerical solution to the factor operation.

38. The system of claim 36, wherein one or more of the one or more attributes of the factor representations are physically manipulated by a user to perform the non-numerical operation to derive the factor operation representation.

39. The system according to claim 36, wherein there are at least four factor representations each comprising a distinct primary color or white attribute and wherein the non-numerical operation is performed by mixing the primary color or white attributes of the factor representations to derive a color product attribute of the factor operation representation.

40. The system according to claim 36, wherein the one or more physical devices are selected from the group consisting of worksheets, blocks, balls, flip cards, dice, dominos, a spin wheel, and a floor mat.

41. The system according to claim 36, wherein there are two numerical factors in the factor operation.

42. The system according to claim 41, wherein each numerical factor is the numeral “6”, “7”, “8”, or “9”.

43. The system according to claim 41, wherein one numerical factor is the numeral “3”, or “4” and the other numerical factor is the numeral “6”, “7”, “8”, or “9”.

44. The system according to claim 41, wherein an attribute of the factor representation of one factor is an outline of an image and an attribute of the factor representation of the other factor is a color, and wherein the non-numerical operation requires the coloring of the outline of the image with the color to derive the factor operation representation.

45. The system of claim 36 combined and delivered with a second system for teaching and learning multiplication and division, comprising a numbered track of numerals from “3” to “12”.

46. The system of claim 46, wherein the numerals “6”, “7”, “8” and “9” on the track are each visually associated with the corresponding factor representations, wherein the corresponding factor representations each have one of the color attributes, “yellow”, “red”, “blue” and “white”.

47. A method for teaching or learning multiplication and division comprising the steps of physically manipulating one or more physical devices having fixed thereon non-numerical representations for numerals and numeric operations, each of said non-numerical representations being distinguishable from the other non-numerical representations by one or more attributes to provide:
i. a factor representation for each numerical factor of a selected factor operation having a numerical solution;
ii. a factor operation representation for the factor operation, derivable by performing a non-numerical operation using one or more of the one or more attributes of each of the factor representations to derive one or more attributes of the factor operation representation; and
iii. a solution representation encoding the numerical solution to the factor operation, comprising a shared attribute in common with the factor operation representation that is derived by performing the non-numerical operation, wherein each numeral in the numerical solution is encoded by a distinct attribute of the solution representation.

48. The method of claim 47, further comprising the step of executing instructions for:
i. recognizing each numerical factor based on the one or more attributes of each factor representation;
ii. applying the non-numerical operation to the factor representations to derive the factor operation representation of the factor operation;
iii. correlating the factor operation representation to the solution representation with reference to the shared attribute; and
iv. decoding the solution representation with reference to its one or more attributes to determine the numerical solution to the factor operation.

49. The method according to claim 47, wherein one or more of the one or more attributes of the factor representations are physically manipulated by a user to perform the non-numerical operation to derive the factor operation representation.

50. The method according to claim 47, wherein there are at least four factor representations each comprising a distinct primary color or white attribute, and wherein the non-numerical operation comprises the step of mixing the primary color or white attributes of the factor representations to derive a color product attribute of the factor operation representation.

51. The method according to claim 47, wherein the one or more physical devices are selected from the group consisting of worksheets, blocks, balls, flip cards, dice, dominos, a spin wheel, and a floor mat.

52. The method according to claim 47, wherein there are two numerical factors in the factor operation.

53. The method according to claim 52, wherein each numerical factor is the numeral “6”, “7”, “8” or “9”.

54. The method according to claim 52, wherein one numerical factor is the numeral “3” or “4” and the other numerical factor is the numeral “6”, “7”, “8”, or “9”.

55. The method according to claim 52, wherein an attribute of the factor representation of one factor is an outline of an image and an attribute of the factor representation of the other factor is a color, and wherein the non-numerical operation requires the coloring of the outline of the image with the color to derive the factor operation representation.
